(19) United States
(12) Patent Application Publication
(10) Pub. No.: US 2017/0036893 A1
(43) Pub. Date: Feb. 9, 2017

(54) APPARATUS FOR MOVING A SHIPPING CONTAINER

(71) Applicant: RSF Enterprises (Aust) Pty Ltd, Fig Tree Pocket (AU)

(72) Inventor: Tommy Schults, Fig Tree Pocket (AU)

(21) Appl. No.: 15/223,970

(22) Filed: Jul. 29, 2016

(30) Foreign Application Priority Data
Aug. 3, 2015 (AU) 2015903088

(51) Int. Cl. B66C 19/00; B65D 88/12

(52) U.S. Cl. CPC B66C 19/007; B65D 88/121

(57) ABSTRACT

A controllably movable machine for moving a shipping container is disclosed. A shipping container can be connected to the machine such that, when the container is connected to the machine and the machine moves, the container moves with the machine. The machine has long-side structural members that extend generally along or adjacent the long sides of the container when the container is connected to the machine, and at least one short-side structural member that extends between the long-side structural members. When the container is connected to the machine, one of the short sides of the container is secured against or relative to the short-side structural member, and the container is secured between the long-side structural members, in such a way that the structure and/or rigidity of the container contributes to or supports the structure and/or rigidity of the machine.

### TECHNICAL FIELD

The present invention relates to apparatus, machines and the like which are configured specifically for moving shipping containers.

### BACKGROUND

Shipping containers come in a range of sizes. Two common shipping container sizes are so-called “20 foot” containers which are approximately 20 ft (6.1 m) long, and so-called “40 foot” containers which are approximately 40 ft (12.2 m) long. Both of these container sizes are approximately 8 ft (2.44 m) wide and approximately 8½ ft-9½ ft (2.6 m-2.9 m) high. By way of example, FIG. 1 shows a typical 20 foot container.

In FIG. 1, one of the container's doors is partly open. It will therefore be understood from this how the container's two doors can be opened (both can be swung wide open to allow the container to be loaded and unloaded) and closed (the doors will be closed when the cargo has all been loaded into the container, or when the container is empty or in storage).

FIG. 1 also illustrates the container's lifting points 9. In the container in FIG. 1 (and this is generally true for all conventional shipping containers) there is a lifting point 9 at the four corners on all four of the container's vertical sides (so 16 lifting points in total on any given container). The lifting points 9 (only the visible ones of which are labelled in FIG. 1) are made as strong or structurally reinforced parts of the container, and each includes a hole (the holes are ovalized or elongated in the vertical direction) into which a chain hook or other attachment mechanism or means can be inserted to lift the container. Typically, containers are lifted either from the top or by the base. If lifted from the top, chains or some other attachment means (possibly associated with a spreader mechanism) may be attached to four of the attachment points at the container's four respective top corners. Then, when the chains or other attachment means is/are subsequently lifted (e.g. by a crane), the container will be lifted off the ground (or off whatever it was previously resting on). When a container is instead to be lifted by its base, chains or some other form of the attachment may be attached to four of the attachment points at the container's four respective bottom corners, and then when the chains or other attachments are subsequently lifted, the container will again be lifted.

When being transported by sea, shipping containers (whether empty or with the cargo being shipped contained therein) are often stacked high aboard large container ships. This will be familiar to those skilled in the art.

There is often also a need to transport shipping containers otherwise than by ship. For example, containers (along with the contents/cargo therein) must often be transported over land, often over large distances, commonly hundreds or thousands of kilometres. Furthermore there is often also a need to move shipping containers over very much shorter distances; for example, to move a container from one position to another within a container yard, or even to move a container from one location to another on the deck of a ship, etc.

For land transportation over large distances (e.g. hundreds or thousands of kilometres), shipping containers are generally transported by conventional road-going trucks, or by rail. However, when moving shipping containers over much shorter distances (e.g. from one position to another within a yard, or from one location to another on the deck of a ship, etc, where distances may often be a few hundred metres or less) specialised container handling machines and equipment are often employed.

Straddle carriers are one kind (or class) of machine specifically designed and often used for lifting and moving shipping containers over shorter distances, for example within a loading yard associated with a factory, or at a storage facility, or at a cargo shipping port, etc. Straddle carriers may be said to fall into two general categories; namely “large” straddle carriers, and small or “mini” straddle carriers. The distinction between the two can perhaps be further understood by noting that large straddle carriers are mainly designed to be used at major cargo shipping ports and like facilities, whereas mini straddle carriers are typically employed for lifting and transporting shipping containers over relatively short distances at smaller, non-port facilities.

By way of further explanation, due to the nature of major shipping port facilities where huge volumes of cargo (i.e. huge numbers of containers) must be loaded, unloaded, moved, etc, on a time-critical basis, the large straddle carriers used at such major port facilities are necessarily very large and heavy pieces of equipment, often capable of lifting two or more full (20 foot or 40 foot) shipping containers at once. Also, to enable cargo to be loaded/unloaded/moved as quickly as possible at major ports, large straddle carriers are often capable of moving (including whilst carrying one or more shipping containers) at relatively high-speeds, often up to 30 km/h (or even faster). Large straddle carriers are also typically designed to be able to lift or carry shipping containers high in the air. This can be important or necessary at major shipping ports where containers are often stacked high, one atop another, sometimes up to four or more high. This may be done for empty containers which are being stored, and/or for full containers which are waiting to be loaded onto ships, etc. Hence, large straddle carriers typically have frame/support/lifting structures which extend high above the ground into the air.

Large straddle carriers can, however, be unsuitable for use in smaller non-shipping-port type applications/facilities such as, for example, at distribution centres or temporary storage yards where smaller numbers of containers are taken (and perhaps temporarily stored) before individual containers are loaded onto trucks (or on to rail, etc) for separate delivery/distribution to their ultimate destination. Distribution centres for supermarket or retail store chains, military storage or maintenance yards, factories, etc, are some examples of facilities that may fall into this category.

There are several reasons why large straddle carriers are often unsuitable for use at/in these kinds of smaller facilities. For one thing, large straddle carriers are often too large, and in particular too high, to fit inside storage warehouses or other buildings or sheds inside which the shipping containers are often kept, or into which they are taken for loading/unloading, etc, at such facilities. Also, the weight of large straddle carriers is often too great for (and would damage/destroy) the concrete or other sealed surface of the yard, roads, etc, on which the straddle carriers operate at such facilities (i.e. the open areas in which the straddle carriers move around at such facilities). The concrete or other sealed surfaces on which large straddle carriers operate at major cargo shipping ports are typically thickened or otherwise strengthened/reinforced to withstand the weight of large straddle carriers.

Mini straddle carriers are therefore typically employed for lifting and transporting shipping containers over relatively short distances at these smaller, non-port facilities. Compared to large straddle carriers, mini straddle carriers are generally much smaller and lower. For example, they normally have a frame/structure high enough to lift no more than one container at a time, and they are normally only high enough to stack containers up to two (or perhaps three) high (and to reach and lift the top container in such a stack). The height of mini straddle carriers is also generally such that they can fit inside, and through the doors of, warehouses, storage sheds, factories, etc. Mini straddle carriers are also generally much lighter than large straddle carriers and are therefore less damaging to the concrete or other sealed surface (yard, roads, etc) on which the mini straddle carriers operate.

As alluded to above in passing, there can sometimes be a need to move individual containers from one location to another on board a ship. Accordingly, some form of shipping-container-moving machine is often required on the ship to allow this to be done.

However, in the context of ships, the issue of weight, and weight-minimization, can be particularly (even extremely) important. Naturally, the total weight that a ship can carry (including the ship's own self-weight, the weight of cargo, the weight of engines and equipment, fuel and provisions, crew, etc) is limited. That is, there is a limit to the amount of weight that a given ship can carry, beyond which the ship may sit too low in the water, or become unstable or difficult/dangerous to operate, especially in the open ocean (or in a worst case scenario too much weight can of course sink a ship completely, if the total weight of the ship and its contents is greater than the weight of the water displaced by the ship's hull.)

With the foregoing in mind it will be understood that, whilst there is often a need for some form of shipping-container-moving machine on board a ship to allow containers to be moved around on board the ship, nevertheless the need for weight minimisation on ships means that “large” straddle carriers (discussed above) are completely unsuitable in this application. Even “mini” straddle carriers (of the kind discussed above) may often be too heavy to be suitable for use on ships. Accordingly, some different form of shipping-container-moving machine may often be required. By way of example, U.S. Pat. No. 6,939,098 to Schults describes a form of shipping-container-moving machine the like of which has previously found use on US Navy warships (the machine in this patent is actually a “two tower” and somewhat straddle carrier-like machine).

Referring still to the above-mentioned issue, namely the need for weight minimisation aboard ships, etc; this is discussed further below with reference to an example. The example referred to involves military warships such as those used by naval armed forces. Many of today's military warships are very large. For example it is quite common for a naval warship to be over 100 m in length. Also, despite their size, such warships are quite commonly also capable of speeds in excess of 40 knots (˜80 km/h). Bearing in mind the size of these warships, and the kinds of equipment and provisions etc that they must carry, and also the number of crew and the length of their deployments at sea before returning to port/land to re-stock, it will be appreciated that it is common for warships of this general kind to carry many shipping containers on board (e.g. containers containing all manner of provisions, supplies, equipment, etc). Accordingly, there is also a need on these warships for one or more shipping-container-moving machines to move the shipping containers from one place to another on the ship as and when needed. And as mentioned above, U.S. Pat. No. 6,939,098 to Schults describes one particular kind of container-moving machine the like of which has previously been used by the US Navy.

However, nowadays, with the changing face of modern warfare, there is an increasing need on naval warships for, among other things, larger and heavier weaponry, particularly e.g. guns, munitions, associated equipment, etc. At the same time though, as explained above, there is a limit to the amount of weight that a given ship can carry, and this applies to military warships just like any other kinds of ship (if not more so).

So, if the weight of weaponry such as guns and munitions, along with associated equipment, etc, that is required on board warships is needing to increase, and assuming there is little or no possibility for (further) reducing the weight of things like the crew, the provisions required by the crew while at sea, fuel and fuel stores, etc, then it follows that it is in relation equipment such as, for example, shipping-container-moving machines and the like that weight reductions may need to be sought, in order to accommodate the increasing weight of weaponry etc.

By way of further example, for reference purposes, machines which embody the invention in the abovementioned U.S. Pat. No. 6,939,098 to Schults typically weigh over 10 Tonnes, and often around 13 Tonnes.

In any case, it is thought that it might be desirable if the above problem could be overcome or at least reduced to some extent. However, it is also to be clearly understood that mere reference herein to any previous or existing machines, apparatus, products, systems, methods, practices, publications or to any other information, or to any problems or issues, does not constitute an acknowledgement or admission that any of those things, whether individually or in any combination, formed part of the common general knowledge of those skilled in the field, or that they are admissible prior art. Also, the fact that the general problem described above has been explained in the context of the need to save weight on board ships, and particularly naval warships, should not be understood to (and it does not) limit the scope of the present invention, or the range of applications, industries or contexts in which the invention may be used or employed. Of course, the invention may well be employed in or applied to machines used for moving shipping containers on board warships, other ships, and the like; however the invention is in no way limited to this, and the invention may equally be employed in or applied to machines used for moving shipping containers in any number of other possible industries, settings or applications.

### SUMMARY OF THE INVENTION

With the foregoing in view, the present invention, in one form, resides broadly in a controllably movable machine for moving a shipping container, wherein a shipping container can be connected to the machine such that, when the container is connected to the machine and the machine moves, the container moves with the machine, the machine having long-side structural members that extend generally along or adjacent the long sides of the container when the container is connected to the machine, and at least one short-side structural member that extends between the (or between some of the) long-side structural members, wherein, when the container is connected to the machine, one of the short sides of the container is secured against or relative to the (or against or relative to at least one of the) short-side structural member(s), and the container is secured between the (or between some of the) long-side structural members, in such a way that the (structure and/or rigidity of the) container contributes to or supports the structure and/or rigidity of the machine.

In another possible form, the present invention may reside broadly in a controllably movable machine for moving a shipping container, wherein a shipping container can be connected to the machine such that, when the container is connected to the machine and the machine moves, the container moves with the machine, the machine having short-side structural members that extend generally along or adjacent the short sides of the container when the container is connected to the machine, and at least one long-side structural member that extends between the (or between some of the) short-side structural members, wherein, when the container is connected to the machine, one of the long sides of the container is secured against or relative to the (or against or relative to at least one of the) long-side structural member(s), and the container is secured between the (or between some of the) short-side structural members, in such a way that the (structure and/or rigidity of the) container contributes to or supports the structure and/or rigidity of the machine. One possible downside of this second form of the invention, compared to embodiments of the first form of the invention described in the previous paragraph above, is that in this second form the short-side structural members extend along or adjacent the short sides of the container when the container is connected to the machine. Accordingly it may not be possible, in embodiments of this second form of the invention, to open the container when the container is connected to the machine (or when the container is positioned to be connected to the machine) because the doors of the container are on one of the container's short (end) sides and these may therefore be blocked by short-side structural member(s) when the container is connected to the machine. Of course, there may be some embodiments of this second form of the invention where, for example, the configuration of the short-side structural members actually allows the container to be opened even while connected to the machine. In any case, in embodiments of the first form of the invention described in the previous paragraph, it may be possible to open the container, even while the container is connected to the machine, because (or if) one of the container's door-containing short sides (ends) remains unimpeded and/or accessible even when the container is connected to the machine. For the avoidance of doubt, explanations and discussions given hereafter about the invention, its various features, embodiments, etc, will refer only to the first form of the invention described the previous paragraph above. However, those skilled in the art will appreciate that many of the explanations and the discussions that follow may also be applied, mutatis mutandis, to embodiments of the second form of the invention described in this paragraph (even though these are not explained or discussed explicitly), and these therefore also fall within the scope of the invention.

One particular benefit provided by the invention lies in the fact that, when the container is connected to the machine, the container contributes to the overall strength and/or rigidity of the machine. In other words, despite the fact that the machine is designed (and its purpose is) to support and move the container when the container is connected thereto, in addition to this, the machine also, in effect, uses the container, and in particular the container's inherent strength/rigidity, to support or reinforce the machine's own strength/rigidity. Thus, the container and its inherent structure/rigidity might be said to (at least to some extent) form part of what supports/reinforces/strengthens the machine when the container is connected to the machine. One possible consequence of this is that it may be possible for the structure of the machine itself to be made with somewhat less self-reinforcing, and/or from less and/or lighter materials, than might otherwise have been possible were this not the case, and this in turn may help to allow the weight of the machine's structure (and indeed the weight of the machine overall) to be reduced.

In any case, the invention in the broad form(s) outlined above relates to a controllably movable machine. In order to be “controllably movable”, the machine may have controls for controlling the movement of the machine. Controls may also be provided for operating the other mechanisms, systems, functions, etc, of the machine. Thus there may be controls for controlling the machine, its movement, and of all its various mechanisms, functions, systems, etc. It is envisaged that, in many embodiments, these various controls may be provided on or as part of the machine itself. For example, the machine may be provided with an attached driver's cabin, or some other form of user-operable control panel located somewhere on the machine, and the machine operator (e.g. a human driver/operator) may thus operate the machine from within the driver's cabin, or whilst standing at/on (or possibly even walking alongside) the machine's control panel.

However, it is to be clearly understood that the invention is not necessarily limited to embodiments in which the controls for controlling the movement and operation of the machine are provided on or as part of the machine itself. Indeed, in other embodiments, the machine may be “controllably movable” in other ways. For example, in some embodiments, the machine may be operated partially or entirely by remote control. In such embodiments, the controls for the machine may be located at a location remote from the machine (possibly in a fixed location, or alternatively in some form of hand-held or otherwise mobile control device/station). The remotely-located controls may be located somewhere within sight of the machine, in which case the operator may be able to watch the machine directly whilst remote-controlling it, or alternatively the controls may be located at an entirely remote location completely out of sight of the machine, in which case the operator might, for example, watch the machine via a video feed whilst remote-controlling it. In any case, wired or wireless signals may be transmitted from the remote-controls to the machine to control the movement and operation of the machine.

It is also to be clearly understood that the invention is not necessarily limited to embodiments in which the machine is operated entirely by a human operator. It is quite possible that embodiments could be provided in which the machine (and the controls that operate the machine) are controlled partially, or even fully, by an automated control system. Such a system might even control the movement and operation of multiple machines at once. Such fully automated/computerised systems (and indeed systems in which human users are partially involved or even fully in control as well) may make use of guidance or tracking systems such as, for example, GPS, RADAR, machine-imaging-based navigation, or indeed any other form of tracking/monitoring system for monitoring the location, speed, orientation, etc, of the machine. The machine may also be provided with a range of, for example, sensors and the like which are operable to monitor, or automatically adjust or control (or shut down in the event of malfunction/failure), or report on, etc, various aspects of the machine or individual components/systems thereof. These kinds of computerised and automated systems may be familiar to those skilled in the art and need not be discussed in any further detail.

Machines in accordance with embodiments of the invention will be designed to (and operable to) move a shipping container. As explained in the Background section above, two common sizes of shipping container are “20 foot” and “40 foot” containers. These are approximately 20 feet and 40 feet long respectively. Both of these container sizes are approximately 8 feet wide and approximately 8½ feet-9½ feet high. There are (or may be) also other sizes of containers. Nevertheless, the point is that shipping containers generally have a rectangular prism (“box”) shape. More specifically shipping containers generally have (and this is true for almost all containers) a flat top/roof, a flat bottom/floor and four vertical walls extending between the floor and the roof to define the overall “box” (i.e. rectangular prism) shape of the container. Of the four vertical walls, two of them—specifically two on opposite parallel sides of the container—are generally longer, and these might be said to be the long “sides” of the container. The other two opposed vertical walls of the container, which are shorter, may therefore be said to be the shorter “ends” the container. Typically, the door(s) which allow(s) the container to be opened and closed, so that goods can be loaded into and unloaded from the container, is/are formed in at least one of the containers shorter “end” walls. In fact, typically, on one short end of the container, the doors (typically two doors which open as shown in FIG. 1) also function as the container's end wall on that end when the doors are closed.

The machine has, or it incorporates, long-side structural members to extend generally along or adjacent the long sides of the container when the container is connected to the machine. The nature of the one or more structural members that form the long side structural members on either side of the machine (i.e. which extend down respective sides of the container) is not necessarily critical. Therefore, in some embodiments, on either side of the machine (i.e. extending along or adjacent the respective long sides of the container), there could be multiple separate long-side structural members, or multiple structural elements which are connected or interconnected or which together form a truss or other framework of long-side structural members. However, in other embodiments, there could simply be a single long-side structural member on either side of the machine (i.e. one that extends along or adjacent to each of the long sides of the container), although as discussed below, in some cases these single long-side structural members may also be length-adjustable.

The machine also has, or it incorporates, at least one short-side structural member that extends between the (or between some of the) long-side structural members. Just like for the long-side structural members described above, in some embodiments, there could be multiple short-side structural members, or multiple structural elements that are connected or interconnected or that together form a truss or other framework of short-side structural members. However, in other embodiments there could simply be a single short-side structural member extending between the long-side structural members on either side of the machine.

As explained above, with the machine according to the form of the present invention that is to be discussed/explained, when the container is connected to the machine, one of the short sides of the container is secured against or relative to the (or against or relative to at least one of the) short-side structural member(s), and the container is secured between the (or between some of the) long-side structural members, in such a way that the container (and its structure and/or rigidity etc) contributes to or supports the structure and/or rigidity of the machine. As will now be appreciated, given the rectangular “box”-like shape of the container wherein the long vertical walls of the container form the “sides” and the short vertical walls form the “ends”, it follows that if one of the short sides (i.e. one of the ends) of the container is secured horizontally against or relative to the (or against or relative to one of the) short-side structural members, this means the container is secured against or relative to the said short-side structural member(s) in the container's horizontal lengthwise direction. On the other hand, again given the shape of the container, if the machine's long-side structural members extend along or adjacent to the respective long sides of the container and the container is secured between the said long-side structural members, it follows that the container must be secured between the said long-side structural members (i.e. prevented from moving in between those long-side structural members) in a horizontally transverse direction perpendicular to the container's lengthwise direction. Thus, the container is secured relative to the machine in both its horizontal lengthwise and horizontal transverse directions. The container (and its inherent rigidity) therefore helps to reinforce the structure of the machine itself in the same horizontal lengthwise and transverse directions. The way in which the container is secured to the machine, as just described, may also help to provide (at least some or a degree) of vertical reinforcement to the structure of the machine.

In some embodiments, there may be two long-side structural members, one extending along or adjacent to each of the respective long sides of the container when the container is connected to the machine. In these embodiments, they may also be a single short-side structural member, and the short-side structural member may extend between the two long-side structural members near one end of the respective long-side structural members. The length of the short-side structural member may be (approximately the same as but) slightly larger than the width of the container (i.e. the container's short-side dimension).

In use (i.e. when the machine is assembled and in, or ready for, operation), when the machine is viewed from above, the plan-form shape (i.e. the shape as seen in two dimensions from above) formed by the two long-side structural members and the short-side structural member (together) may be (or it may include) a general “U”-shape (or “I I”-shape) into which the shipping container can be inserted lengthwise to be connected to the machine. The two long-side structural members and the short-side structural member may all reside in a plane substantially parallel to the ground and may together form a flat, horizontally extending “U”-shape (or “I I”-shape) into which the shipping container can be inserted lengthwise to be connected to the machine.

The machine may further comprise a plurality of wheel assemblies, wherein wheels of the wheel assemblies contact the ground and the wheel assemblies support the long-side structural members and the short-side structural member(s) above the ground. In some embodiments, there may be at least one wheel assembly at or near the end of the machine where the short-side structural member extends between the two long-side structural members, and at least one wheel assembly supporting each respective long-side structural member near the opposite end thereof from the end connected to the short-side structural member. In some particular embodiments, the machine may have a total of eight wheel assemblies, four attached directly or indirectly to each long-side structural member, and of four the wheel assemblies attached to each long-side structural member two may be located towards the end of said long-side structural member that is connected to the short-side structural member and two may be located toward the opposite end. It may be that all of the machine's wheel assemblies (or alternatively only some of the wheel assemblies), or steering mechanism(s) associated therewith, can be operated such that their respective wheels pivot about a vertical axis to contribute to turning/steering the machine. Similarly, it may be that all of the machine's wheels are “driven”, or alternatively only some of the wheels may be “driven”.

The machine may be operable, once a container that is resting on the ground is connected to the machine, to lift the container off the ground to a sufficient height for the container to be subsequently moved without dragging along the ground or without striking the ground as it is moved over uneven sections of ground, and the machine may also be operable to lower the container back down onto the ground. Suitably, when the container is connected to the machine, the container may be fixed in position relative to the long-side and short-side structural members, and the machine may operate to lift, and lower, the container by respectively raising, and lowering, the long-side and short-side structural members relative to the ground. In some embodiments the wheel assemblies (or some of them) may incorporate mechanisms operable to raise, and lower, the long-side and short-side structural members relative to the ground.

The machine may have attachment points where the machine connects to the container in order that, when the container is connected to the machine, the container is fixed in position relative to the long-side and short-side structural members. There may often be at least four attachment points where the machine connects to the container near the lower corners of the container. In some cases, the attachment points may be located on structural parts of the machine that hang or otherwise reside below the short-side and long-side structural members. A mechanism may be provided at some or all of the attachment points that both connects the attachment point to a point on the container and also secures the said point on the container against (or otherwise relative to) the attachment point. In some instances, the mechanism provided at some or all of the attachment points may be a twist lock mechanism.

The machine may be extendable to accommodate (i.e. to be able to connect to) containers of differing long-side dimensions. Where this is the case, the two long-side structural members may each be made up of multiple parts, and in each case one or more of the parts may be movable relative to one or more other parts such that the machine is extendable to accommodate containers of differing long-side dimensions.

The machine may also be operable to lift a container to a height sufficient to place the container on top of another container or onto a road-going or rail vehicle or the like. In some cases, it may be that, when the container is connected to the machine, the container is fixed in position relative to the long-side and short-side structural members, and the machine may operate to lift, and lower, the container by respectively raising, and lowering, the long-side and short-side structural members relative to the ground, and the machine may incorporate a plurality of height-adjustable frame members which are operable to raise, and lower, the long-side and short-side structural members. It is envisaged that, sometimes, the plurality of height-adjustable frame members may be or include a plurality of telescopically height-adjustable uprights. If so, the machine's wheel assemblies may be connected directly to wheel assembly support members (bogies), the height-adjustable uprights may connect the wheel assembly support members to the long-side and short-side structural members, and increasing or decreasing the height of the uprights may cause the vertical distance between the wheel assembly support members and the long-side and short-side structural members to increase or decrease.

Any of the features described herein can be combined in any combination with any one or more of the other features described herein within the scope of the invention.

### BRIEF DESCRIPTION OF THE FIGURES

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of figures as follows:

FIG. 1—Example 20 foot shipping container.

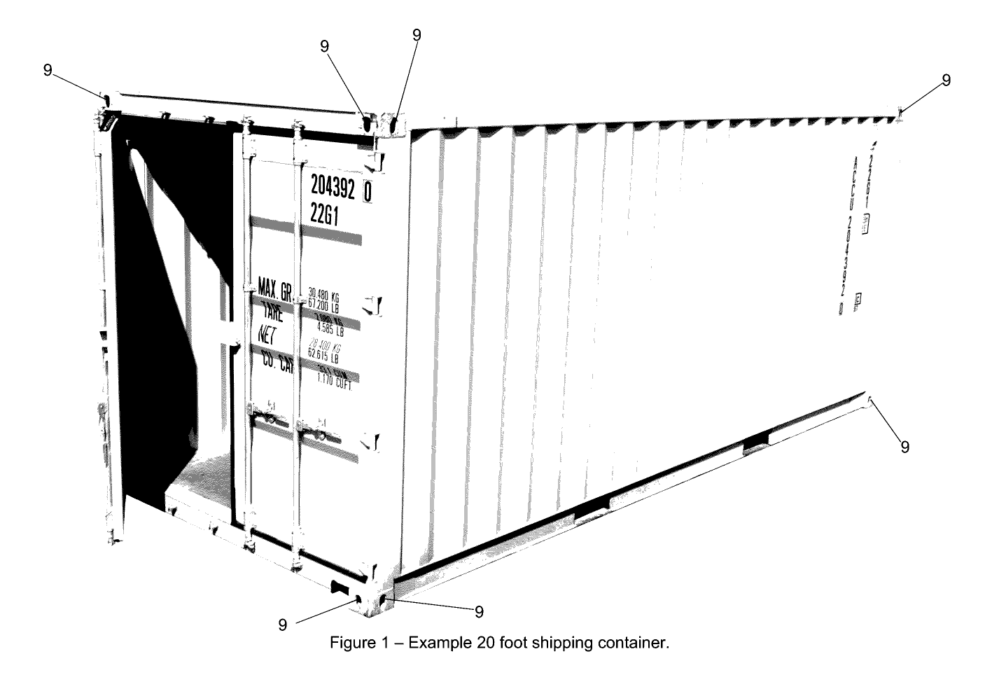

FIG. 2—Perspective view of a lightweight container moving machine when moving a 20 foot container.

FIG. 3—Side view of the lightweight container moving machine when moving a 20 foot container.

FIG. 4—Top (plan) view of the lightweight container moving machine when moving a 20 foot container.

FIG. 5—Rear view of the lightweight container moving machine when moving a 20 foot container.

FIG. 6—Perspective view of a length-adjustable and height-adjustable container moving machine when unextended and raised to (at least approx) full height while carrying a 20 foot container.

FIG. 7—Side view of the length-adjustable and height-adjustable container moving machine when unextended and raised to (at least approx) full height while carrying a 20 foot container.

FIG. 8—Perspective view of the length-adjustable and height-adjustable container moving machine when unextended and lowered.

FIG. 9—Perspective view of the length-adjustable and height-adjustable container moving machine when unextended and raised only a small amount, sufficient to carry a 20 foot container.

FIG. 10—Perspective view of the length-adjustable and height-adjustable container moving machine when lowered and extended.

FIG. 11—Another perspective view of the length-adjustable and height-adjustable container moving machine when lowered and extended.

FIG. 12—Perspective view of the length-adjustable and height-adjustable container moving machine when extended, carrying a 40 foot container, and moving with the container raised high enough to position the container onto the tralier tray of a road-going truck.

FIG. 13—Perspective view of a slight variant of the length-adjustable and height-adjustable container moving machine when unextended and raised only a small amount, sufficient to carry a 20 foot container.

FIG. 14—Perspective view of the slight variant of the a length-adjustable and height-adjustable container moving machine when extended and lowered.

### DETAILED DESCRIPTION

### Lightweight Container Moving Machine

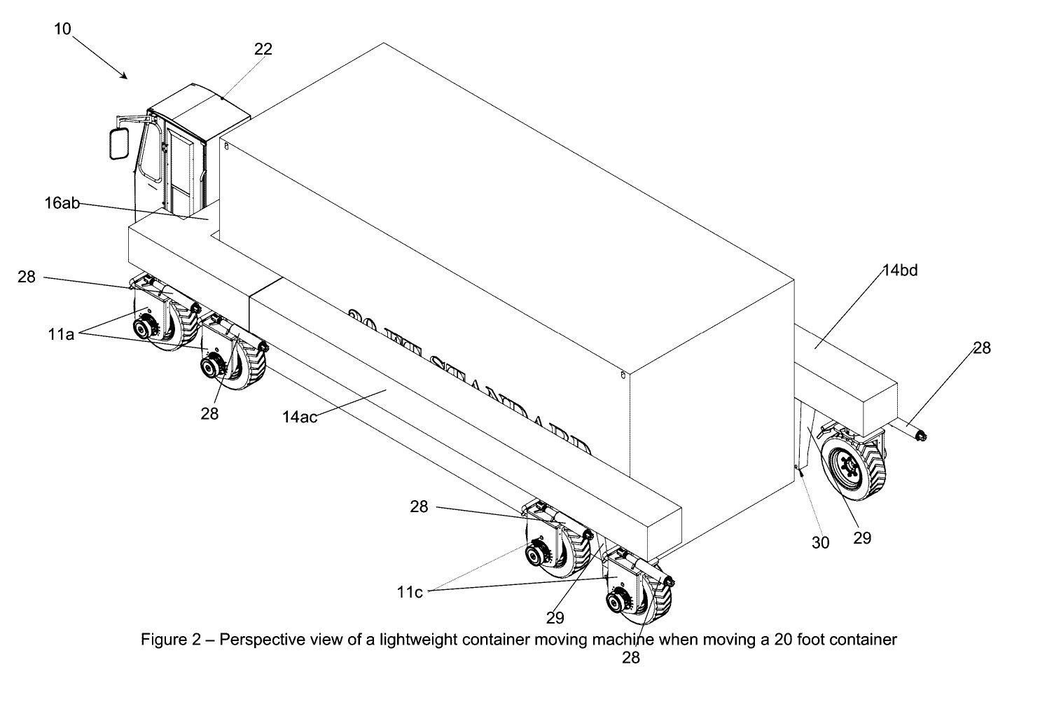

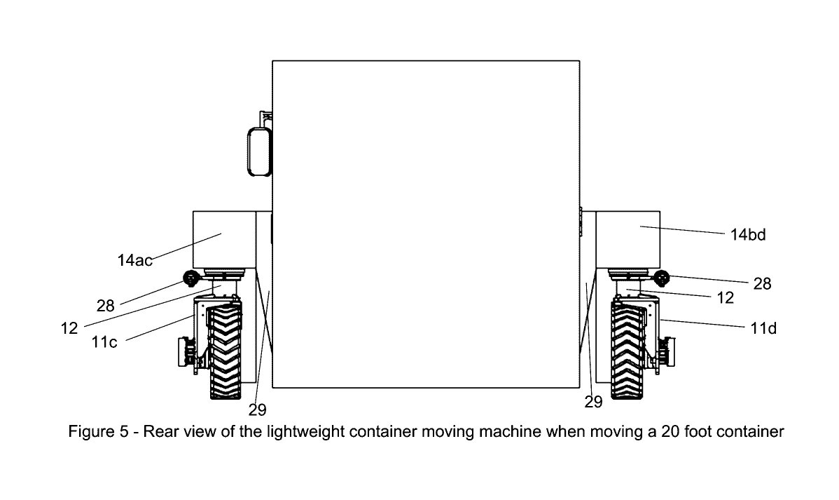

The first embodiment of the present invention that will be described is a lightweight container moving machine 10 designed for moving a 20 foot shipping container, as shown in FIG. 2 to FIG. 5. From these Figures, it can be seen that the lightweight machine 10 in this particular embodiment has eight wheels (other embodiments might have, say, only four wheels). In fact, in this embodiment, there is a wheel assembly 11 associated with each wheel, so there are a total of eight wheel assemblies 11. The wheels (and wheel assemblies 11) are arranged on the machine such that there are four sets of two wheels/wheel assemblies each. Two of the wheel assemblies (11a) provide the machine's front left wheels, two of them (11b) provide front right wheels, two of them (11c) provide the rear left wheels, and two (11d) provide the rear right wheels.

In this embodiment, the wheel assemblies 11a-11d are all connected to one another by the main structural frame members of the machine 10. These structural frame members include:
an elongate (long-side) longitudinal bearer 14ac on the machine's left,
an elongate (long-side) longitudinal bearer 14bd on the machine's right, and
a transverse (short-side) member 16ab which extends between the bearers 14ac and 14bd near the front of the machine (i.e. the transverse member 16ab connects at right angles to the two side bearers 14ac and 14bd, and it connects the two side bearers 14ac and 14bd together, at or very near their respective forward ends).

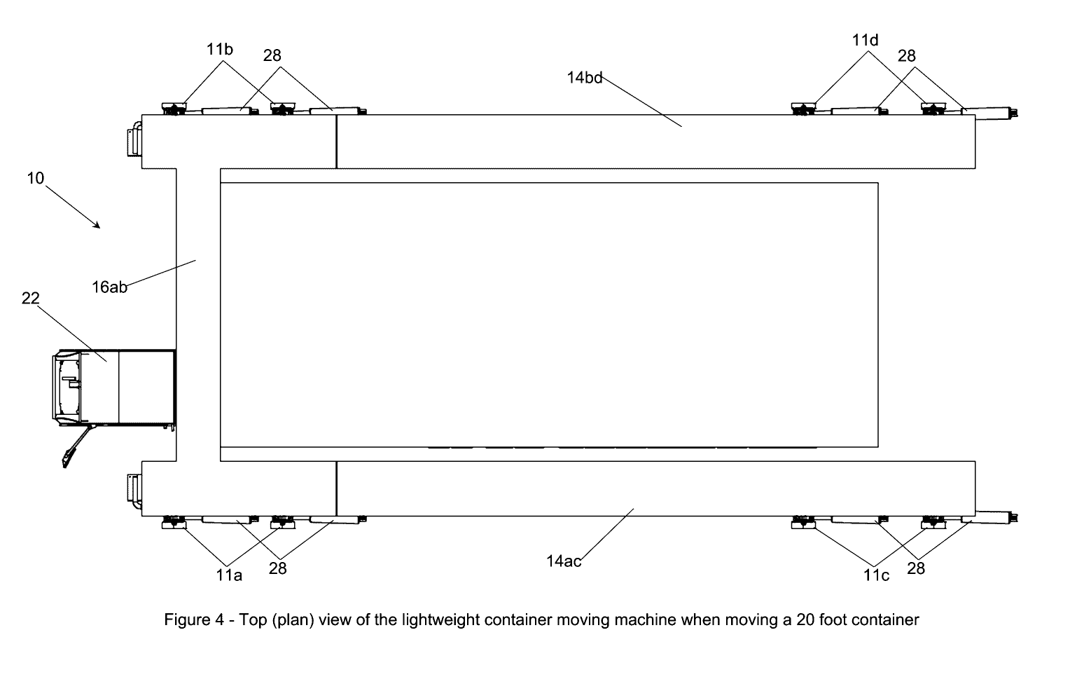

The machine 10 has a driver's cabin 22. The controls for operating the machine are located inside the cabin 22, such that a driver can sit inside the cabin 22 to drive the machine and also to operate the machine's other functions (e.g. the mechanisms for attaching to, and lifting, a container—see below). The driver's cabin 22 in this embodiment is mounted on the forward-facing (front) edge of the transverse member 16ab. The driver's cabin 22 is therefore located at the front of the machine and faces forward. However, it will be noted from FIG. 4 that the driver's cabin 22 is not located centrally on the transverse member 16ab. Rather, it is offset somewhat to one side (towards the left hand side of the machine in the particular embodiment shown). This slight offset position of the driver's cabin 22 is to provide room beside the driver's cabin for mounting other equipment (e.g. the machine's engine, etc—see below) to the transverse member 16ab.

Whilst not shown in FIG. 2 to FIG. 5, in this embodiment the lightweight machine's engine, as well as other hydraulic pumps and the like, will generally be mounted to the transverse member 16ab in the space beside the driver's cabin 22 (although it is to be noted that the engine, etc, could alternatively be mounted to one or other of the elongate bearers, for example, or on some other part of the machine). Normally, the engine, hydraulic pumps and other like equipment will be housed inside an engine cover (although, again, the engine cover is not shown). Nevertheless, if mounted to the transverse member 16ab beside the driver's cabin 22, the engine cover could be positioned on the top or the front of the transverse member 16ab. A fuel tank (also not shown) may also be supported within (or adjacent or nearby) the engine cover.

As mentioned above, pump(s) (which may be engine driven or separately powered), and also valves, etc, which operate the machine's hydraulic systems (based on driver controls) may also be located near the engine, nearby or even inside the engine cover. Hydraulic lines (not shown) which convey fluid to different parts of the machine may run along the machine's various frame members. For example, there would normally be hydraulic lines extending from the pump (usually near the engine), along the relevant intervening sections of the machine's frame, to the respective hydraulic motors that drive each of the machine's wheels (these hydraulic motors are incorporated in and form part of the respective wheel assemblies 11 but the hydraulic motors themselves are no specifically labelled). Thus, in the depicted embodiment, all of the wheels are “driven” wheels. However, it is possible that in other embodiments, only some wheels (e.g. only the rear wheels, or only the front wheels, etc) of the machine may be driven (e.g. only some of them may have hydraulic motors, or only some of them may be driven in some other way).

In some other embodiments (which differ from the embodiment depicted in FIG. 2 to FIG. 5), only some wheels (e.g. only the front wheels) of the machine may operate to steer the machine. However, in the embodiment actually depicted in FIG. 2 to FIG. 5, all of the machine's wheels can pivot about a vertical axis to contribute to turning/steering the machine when it is in motion. (Or, perhaps more accurately, all of the machine's wheel assemblies 11, or the steering system associated therewith, can be operated such that their respective wheels can be made to pivot appropriately about a vertical axis to contribute to turning/steering the machine). In any case, the machine in the embodiment depicted in FIG. 2 to FIG. 5 has “8-wheel steering”.

Whilst all of the machine's wheels can potentially pivot/turn at the same time (i.e. all at once) to steer the machine, the amount that each wheel pivots/turns, and the direction in which it pivots/turns, relative to the amount and direction that the others turn, may differ. This is so that the respective wheels each turn in the correct direction and by the correct amount to steer the machine along the desired trajectory. The reason why some or all of the wheels will often turn by a different direction and/or amount compared to others is because the wheels are all located at different positions on the machine, and they must all therefore trace out curved paths of different instantaneous radii as the machine is steered.

To facilitate steering of the machine, powered and controllable steering linkages 28 are provided. The hydraulic cylinders of the respective steering linkages 28 are visible in FIG. 2 to FIG. 5. The respective steering linkages (including the respective hydraulic cylinders thereof) are connected to each of the wheel assemblies 11 and also (in each case) to the respective bearer 14ac or 14bd, and the respective steering linkages (including by operation of the respective hydraulic cylinders) control the pivoting of the respective wheel assemblies to ensure that the machine's wheels all turn in the correct direction and by the correct amount when steering the machine. The machine can be steered using controls housed in the driver's cabin 22. In other words, controls in the driver's cabin 22 can be used to operate the steering linkages 28, which in turn pivot (i.e. change the orientation of) the wheels. Naturally, if this is done while the wheels are being driven (by their internal hydraulic motors) to impart motion to the machine, the machine will “corner” (i.e. it will traverse a curved path determined according to the instantaneous orientation of the wheels).

The machine in the embodiment depicted in FIG. 2 to FIG. 5 is also operable to lift a shipping container, so that the machine can, in effect, “pick up” a container that is initially resting on the ground and then move that container to another location. It is to be noted that the lightweight container moving machine in the embodiment in FIG. 2 to FIG. 5 cannot lift the container very high (and in this way this lightweight machine is different to the machines in other embodiments discussed below). Rather, the lightweight container moving machine in the embodiment depicted in FIG. 2 to FIG. 5 can lift a container only sufficiently high for the container to be subsequently moved without dragging along the ground, or without striking the ground as it is moved over uneven sections of ground, etc. As a guide, although without limitation, the height to which the machine in FIG. 2 to FIG. 5 may be able to lift a container might be, say, 100 mm-300 mm.

The mechanism by which the machine depicted in FIG. 2 to FIG. 5 lifts a shipping container is not specifically shown or labelled in these Figures. However, it will be seen that each of the respective wheel assemblies 11 includes a vertical “strut” portion 12. On each wheel assembly 11, the strut 12 is the portion of the wheel assembly that connects wheel assembly to the relevant bearer 14ac or 14bd above. In any case, in each of the wheel assemblies 11, the strut 12 incorporates a hydraulic ram or other lifting mechanism, thus making the strut height-adjustable. Therefore, the respective struts 12 can be used to raise, and lower, the respective bearers 14ac and 14bd relative to the ground (and hence raise, and lower, the machine's whole frame and everything attached to it, including a container when a container is attached to the frame).

In the embodiment of the lightweight machine depicted in FIG. 2 to FIG. 5, twist-lock mechanisms, which are not specifically illustrated but which form part of the machine, are used for attaching the container to the machine. (The twist lock mechanisms may be, for example, hydraulically or electrically operated and controllable from within the driver's cabin 22.) There is a twist lock mechanism for attaching to each of the four bottom corners of a 20 foot container. The twist lock mechanisms are all located on the lower ends of respective downward-hanging structural members 29 (although the twist lock mechanisms could alternatively be located on other low-hanging or on otherwise low or close-to-the-ground portions of the machine).

As mentioned above, the twist lock mechanisms themselves are not specifically illustrated. Nevertheless, each twist lock mechanism includes a rotatable lock part which is shaped in such a way that, when attaching a container to the machine, the said lock part of each twist lock mechanism initially inserts through and into one of the ovalized holes 9 in a respective one of the container's lower corners. Once inserted into the hole 9, the lock part of each twist lock mechanism then twists (i.e. each lock part twists when its twist lock mechanism is operated), and because of the shape of the lock part (compared to the ovalized shape of the hole 9), when the lock part twists inside the hole 9, this then prevents the lock part from being withdrawn back out through the hole. More specifically, this twisting causes the lock part (which is then inside the hole 9) to become misaligned with the ovalized hole 9, so that the lock part cannot then be withdrawn from the hole, at least not until the twist lock mechanism is operated again to rotate the lock part back the other way for withdrawal from the hole. Additionally, when one of the lock parts is inserted into one of the holes 9 and twisted, not only does this prevent the lock part from then being withdrawn from the hole, as just described, it also (again due to the shape of the lock part) causes the metal/material of the container around the hole 9 (and hence the container itself as a whole) to be pulled tight and secured firm against the twist lock mechanism. This may arise due to a camming action by (and due to the shape of) the lock part, for example. Therefore, not only does the turning/twisting of the lock parts in the respective holes 9 secure the lock parts inside the holes, it also pulls the container tight against the respective twist lock mechanisms, thus securing (i.e. holding) the container in position.

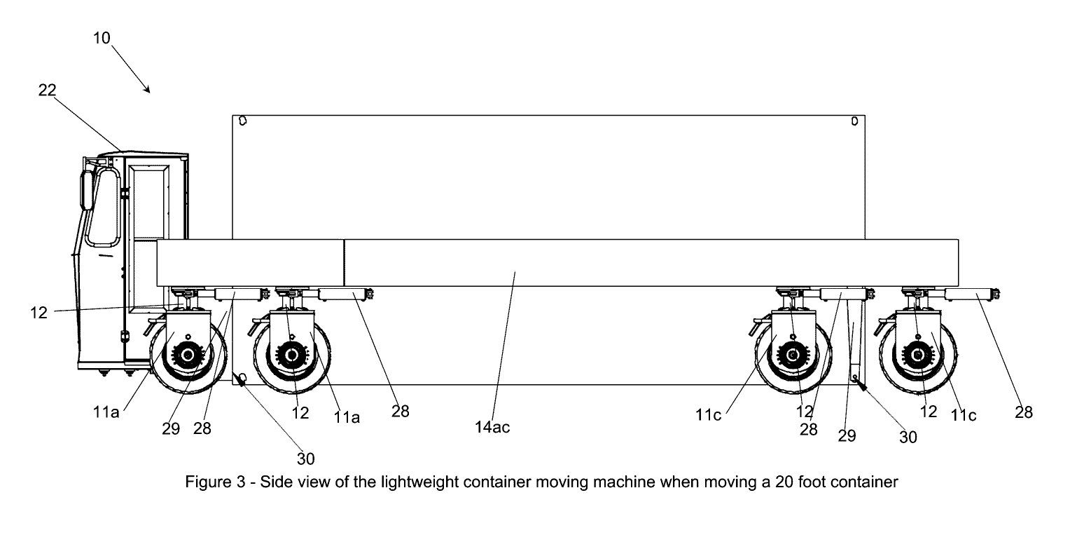

The general way in which the twist lock mechanisms operate is described in the previous paragraph. However, it is important to note the locations of the twist lock mechanisms, and hence the locations where the container attaches to the machine 10, in the embodiment depicted in FIG. 2 to FIG. 5. The locations of the twist lock mechanisms, and hence the locations where the container attaches to the machine in this embodiment, are labelled 30 (see FIG. 3).

It is useful to first consider the locations of the attachment points (i.e. the locations of the twist locks where the container attaches to the machine) at the front-end of the machine. Recall that the twist locks are located on the bottom ends of structural members 29. Also, as can be readily understood from FIG. 3, the structural members 29 at the front end of the machine 10 extend downward directly below the transverse frame member 16ab. In fact, the location 30 of the two twist lock mechanisms at the front of the machine, namely the two which allow the two lower corners of a container to connect at the front end of the machine, are in the same vertical plane and immediately below the rear vertical edge/face of the transverse frame member 16ab. Also, these two twist lock mechanisms face in the machine's rearward direction and so they connect with the two holes 9 that are on the lower side of the short, forward-facing wall of the container. Furthermore, because the twist lock mechanisms operate to pull the container firmly against themselves when the lock part is inserted into the container holes and twisted, it follows that when a container is attached to the machine 10, and in particular, when the forward end of the container is connected to the two twist lock mechanisms at the front of the machine and these are operated/twisted, the front end of the container (i.e. the container's forward facing wall) is pulled firmly against not only the twist locks but also against the rear vertical edge/face of the transverse frame member 16ab. Thus, the forward-facing end wall of the container is secured firmly against the two twist locks at the bottom of the structural members 29 and also pressed firmly against the back of the transverse frame member 16ab.

Turning now to consider the locations of the attachment points at the rear-end of the machine, it can be seen from FIG. 2 and FIG. 3 that the structural members 29 at the rear end of the machine 10 extend downward from the near the back of the respective bearers 14ac and 14bd. The two rear twist lock mechanisms both face inwards in the machine's transverse direction, so they connect with the holes 9 that are on the lower rear end of the container, on the respective long, outward-facing walls of the container. Because each twist lock mechanism operates to pull the container firmly against itself when the lock part thereof is inserted into the container hole and twisted, it follows that when a container is attached to the machine 10, and in particular, when the rear end of the container is connected to both of the two respective inward-pointing twist lock mechanisms on either side at the rear end of the machine and these are operated/twisted, at the rear, the two sides of the container are pulled away from each other in opposite directions by the opposing rear twist locks. The result is that the container becomes rigidly held, in tension, between the two rear twist locks of the machine to which it is secured, and in fact this helps secure/reinforce the rear end of the machine 10 itself by, for example, helping to prevent outward flexure of the respective bearers 14ac and 14bd relative to one another.

Therefore, when a container is secured to the machine 10, at the front the forward-facing end wall of the container is pressed/engaged (and held) firmly against the two front twist locks and against the back of the transverse frame member 16ab, and at the rear the container is rigidly secured, in tension, between the two rear twist locks. Hence, the container is securely attached to the machine (so the container can be safely moved if lifted and then driven by the machine), but in addition to this, the container in fact also helps to reinforce (or improve the overall rigidity of) the machine itself, because the container is pulled firmly against (or relative to) the machine in both longitudinal and transverse directions, meaning that the machine is effectively stiffened in both directions by the container. In other words, the design of the machine allows the inherent structural rigidity and stiffness of the container to be used to enhance the rigidity and stiffness of the machine (thus helping to, for example, prevent outward flexure of the respective bearers 14ac and 14bd relative to one another, as discussed above). Accordingly, it may be possible for the structure of the machine itself to be made with less self-reinforcing, and/or from less and/or lighter materials, than might otherwise have been possible had this not been the case, and this in turn may help to allow the weight of the machine's structure (and indeed the weight of the machine overall) to be significantly reduced. And the significance of this will be readily appreciated in light of the issues discussed in the Background section above.

At this point it should be noted that alternative embodiments may be provided in which the machine does not have any twist locks or other mechanisms that connect to the forward-facing end wall of the container. For example, there may be embodiments (not illustrated) in which the machine is almost the same as in FIG. 2 to FIG. 5, but where the machine only has structural members 29 depending down from the side bearers 14ac and 14bd and hence only has inwardly (transversely) facing twist locks that connect to the bottom corners of the long sides of the container (i.e. such that the machine only connects to the long sides of the container). In such embodiments, the container consequently may not be pressed/engaged (and held) firmly against the back of the transverse frame member 16ab, for example, or at least not by the operation of the twist locks. Nevertheless, in such embodiments, the container may still be held firmly by the said (all inward/transversely facing) twist locks, including being held firmly in the container/machine's lengthwise direction. In other words, this possible alternative arrangement may still operate (or be capable of operating) to secure the short side of the container (and indeed the container as a whole as a result) and hold it in position relative to the machine's short-side structural member 16ab (and thus relative to the machine is a whole). Hence, this alternative configuration may also allow the inherent structural rigidity and stiffness of the container to be used to enhance the rigidity and stiffness of the machine. And so, again, it may be possible for the structure of the machine itself to be made with less self-reinforcing, and/or from less and/or lighter materials, than might otherwise have been possible had this not been the case, and this in turn may help to allow the weight of the machine's structure (and indeed the weight of the machine overall) to be significantly reduced.

To help further illustrate this point, recall from above that machines which embody the invention in U.S. Pat. No. 6,939,098 to Schults (which have previously been used on US naval warships) typically weigh over 10 Tonnes, and often around 13 Tonnes. In comparison, it is estimated that a machine corresponding to the embodiment depicted in FIG. 2 to FIG. 5, if manufactured using conventional materials (e.g. conventional structural steel for the structural fame members) and using other conventional parts (e.g. conventional engine, pumps, wheel assemblies, tires, driver's cab, etc), could weigh less than 8 Tonnes, and possibly even a little as 5 Tonnes. The significance of this weight difference is self-evident.

### Length-Adjustable and Height-Adjustable Container Moving Machine

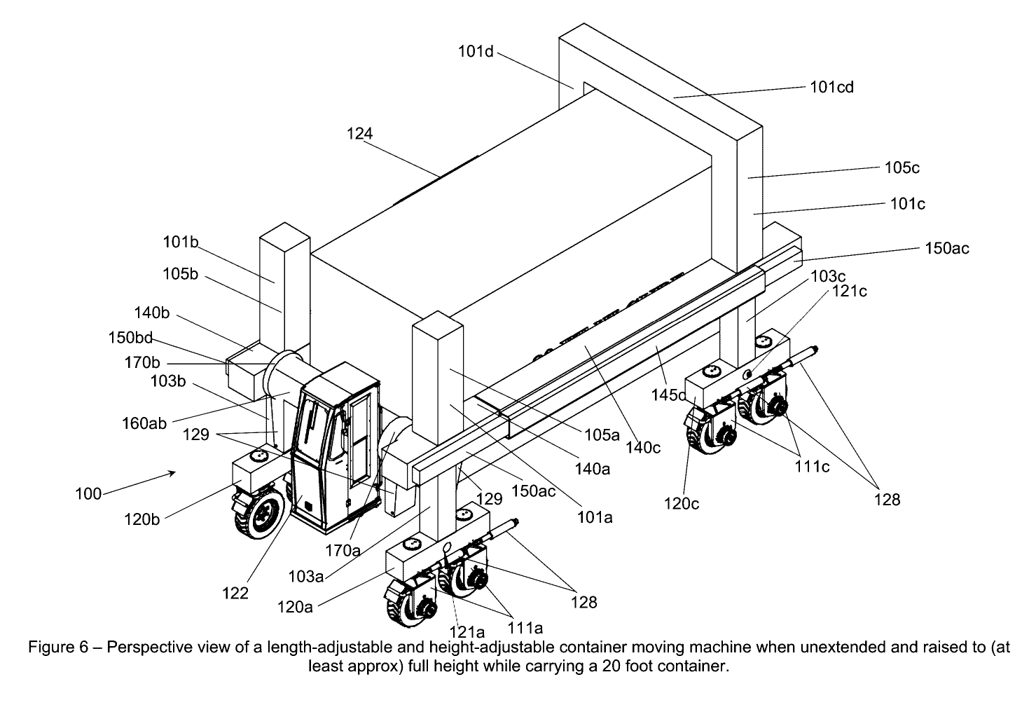

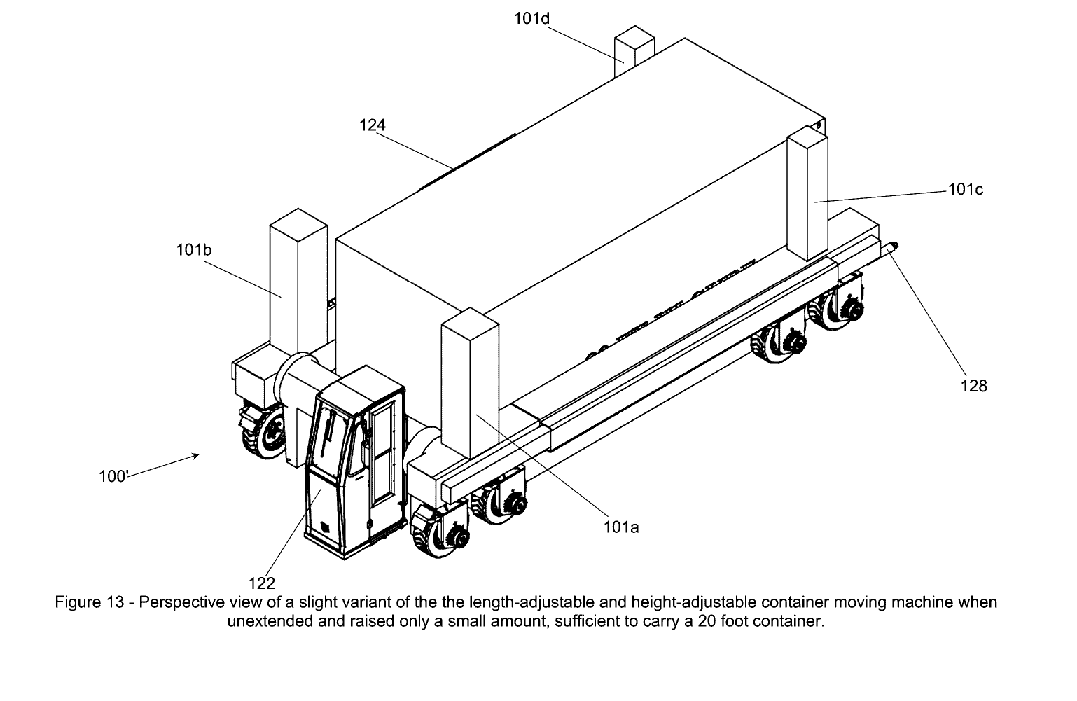

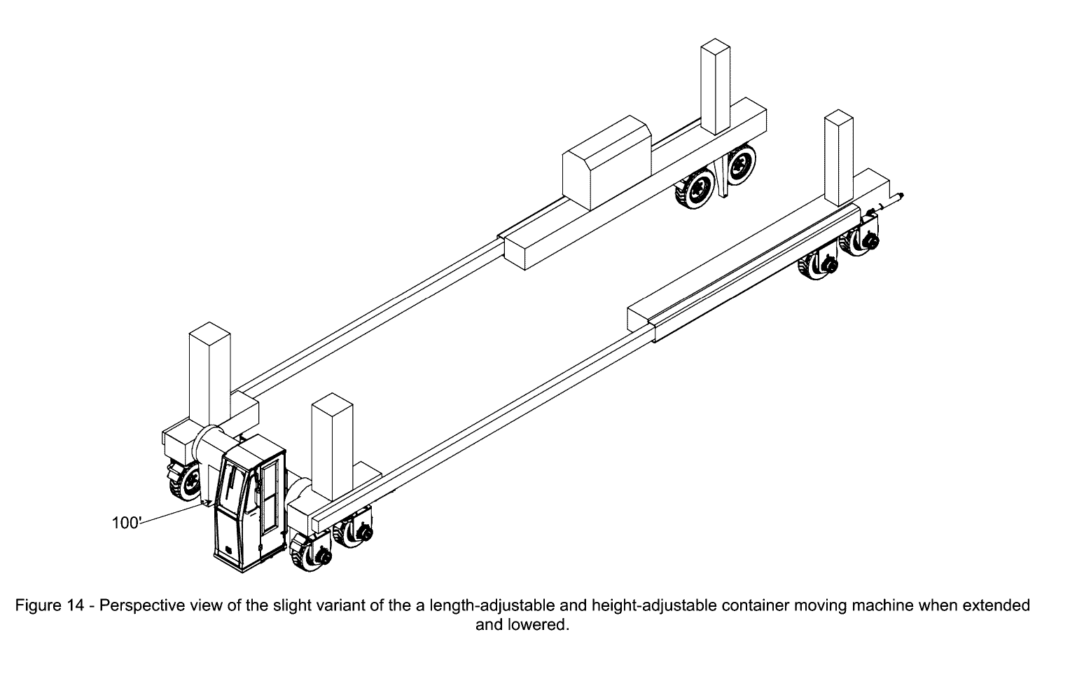

Other possible embodiments of the present invention, which are length-adjustable and height-adjustable, will now be described with reference to FIG. 6 to FIG. 14. FIG. 6 to FIG. 12 show one particular length-adjustable and height-adjustable container moving machine 100, whereas FIG. 13 and FIG. 14 show a slight variant length-adjustable and height-adjustable machine 100′. The difference between the machine 100 in FIG. 6 to FIG. 12 and the machine 100′ in FIG. 13 and FIG. 14 will be discussed below.

In the embodiment in FIG. 6 to FIG. 12, the frame of the machine 100 includes four main uprights (a.k.a. legs) 101a-101d. Uprights/legs 101a and 101b are the machine's front left and front right uprights, respectively, and uprights/legs 101c and 101d are the rear left and rear right uprights, respectively. Also, in the embodiment in FIG. 6 to FIG. 12, the top of the machine's rear legs 101c and 101d are connected by a connecting cross-member 101cd. The purpose/function of the cross-member 101cd is to add rigidity and stiffness to the machine's overall structure, particularly at the rear end (this additional stiffness or structural reinforcement may be important, for example, when the length of the machine is extended as discussed below). However, it should be noted that this cross-member 101cd need not always be included. In some cases it may not be required, or the benefit of improved rigidity may be outweighed by the more restricted access or physical obstacle the cross-member 101cd may create (which may affect ease of container handling etc). In fact, the cross-member 101cd is not included (i.e. there is no cross member) in the variant embodiment depicted in FIG. 13 and FIG. 14. This difference, namely the absence of the cross-member, is actually the only difference in the variant embodiment in depicted in FIG. 13 and FIG. 14 compared to the embodiment in FIG. 6 to FIG. 12. These two embodiments are therefore otherwise the same and will hereafter be described together, in effect, as one.

The respective legs 101a-101d of the machine are supported above the ground by wheeled bogies 120. The bogie connected to the base of upright 101a is labelled as bogie 120a, the bogie connected to the base of upright 101b is labelled as bogie 120b, etc. Note that in Figures in which the machine 100/100′ is depicted in a lowered configuration, the bogies are generally not visible because they are hidden behind (or beneath) other parts of the machine, namely parts of the machine which become positioned on top of the bogies when the machine is lowered. The bogies will be discussed further below.

Each of the legs 101a-101d is height adjustable in a generally telescopic manner. To facilitate this, it will be seen that legs 101a-101d each have a two part construction. The two parts of leg 101a are the lower pillar (or main pillar) 103a and the upper slider 105a. Similarly, leg 101b has a lower pillar 103b and an upper slider 105b, and it is the same for the other legs as well.

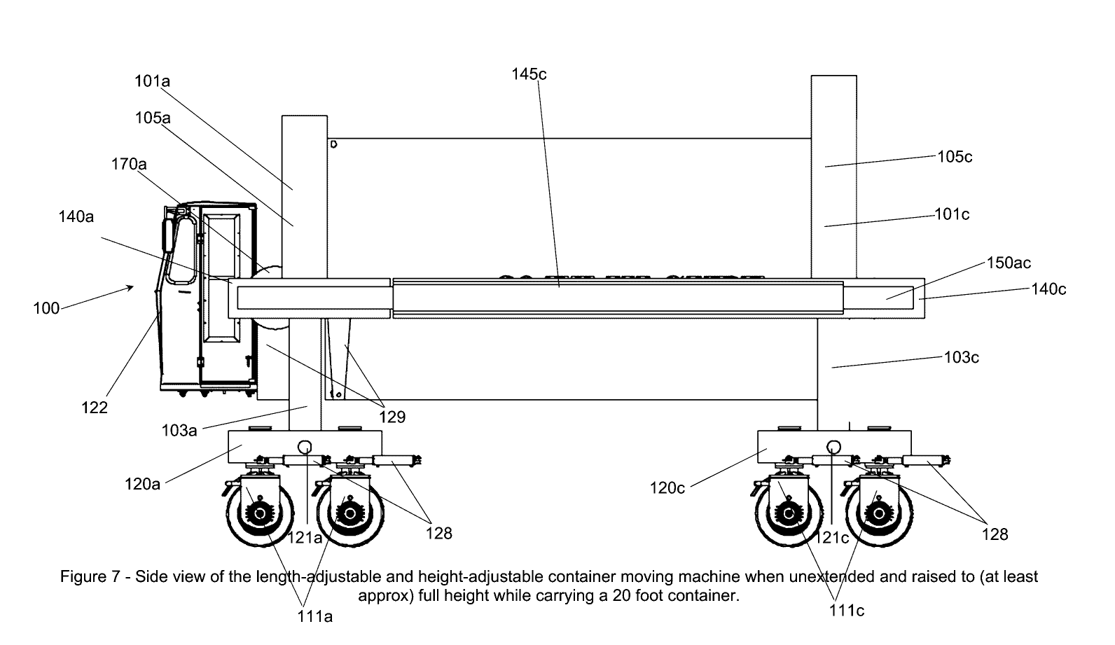

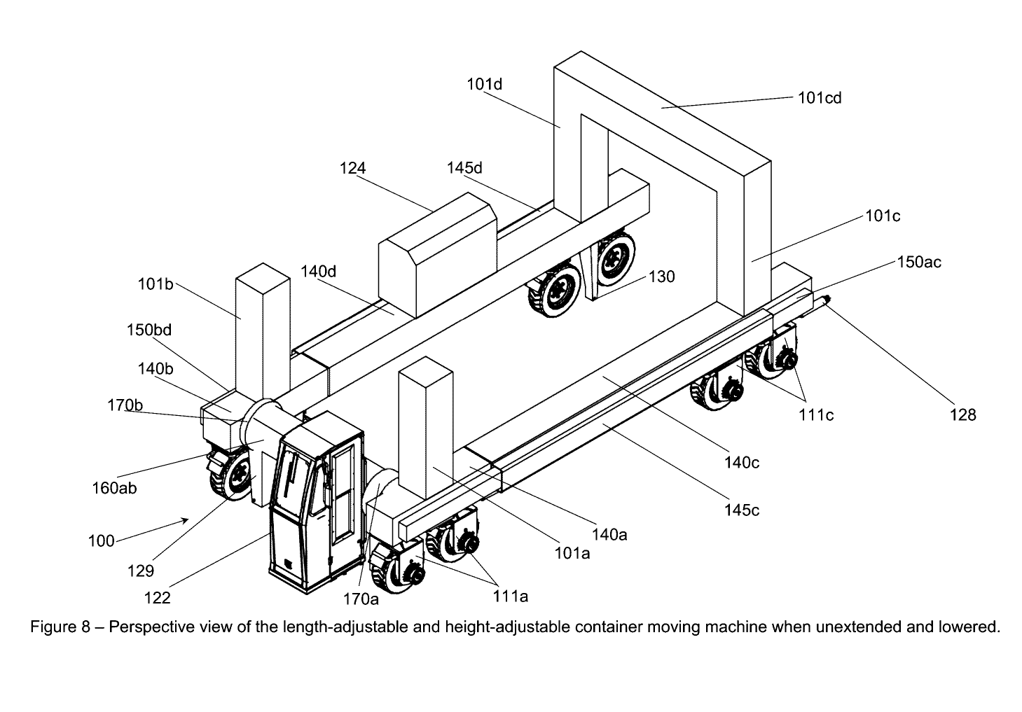

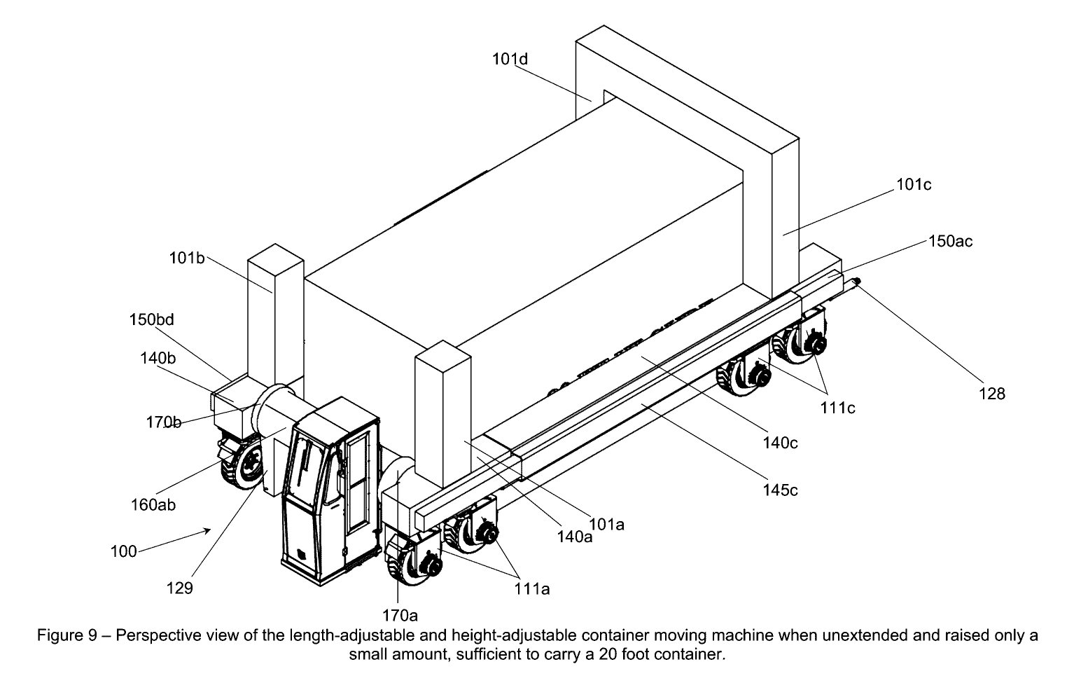

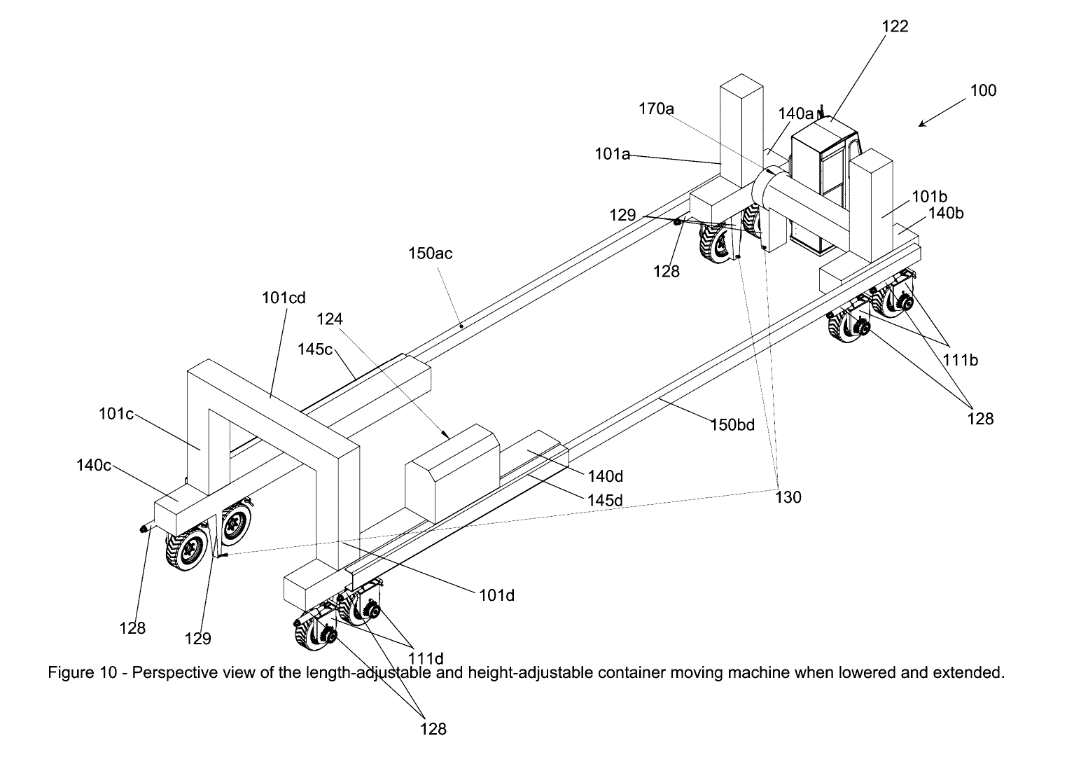

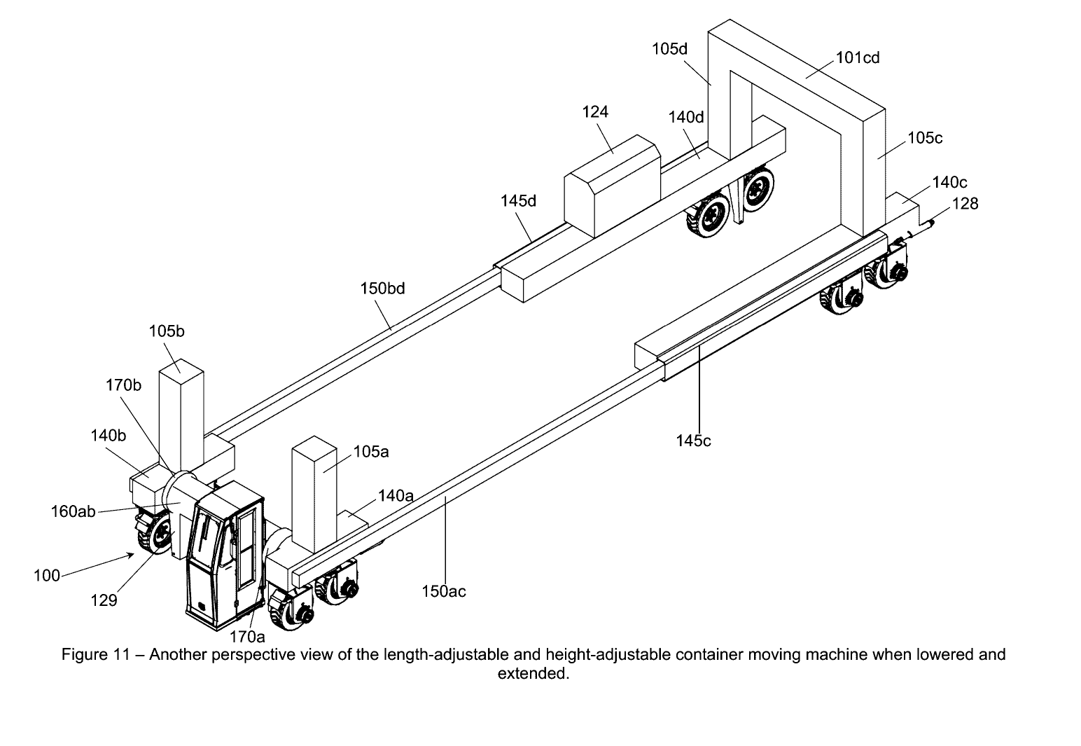

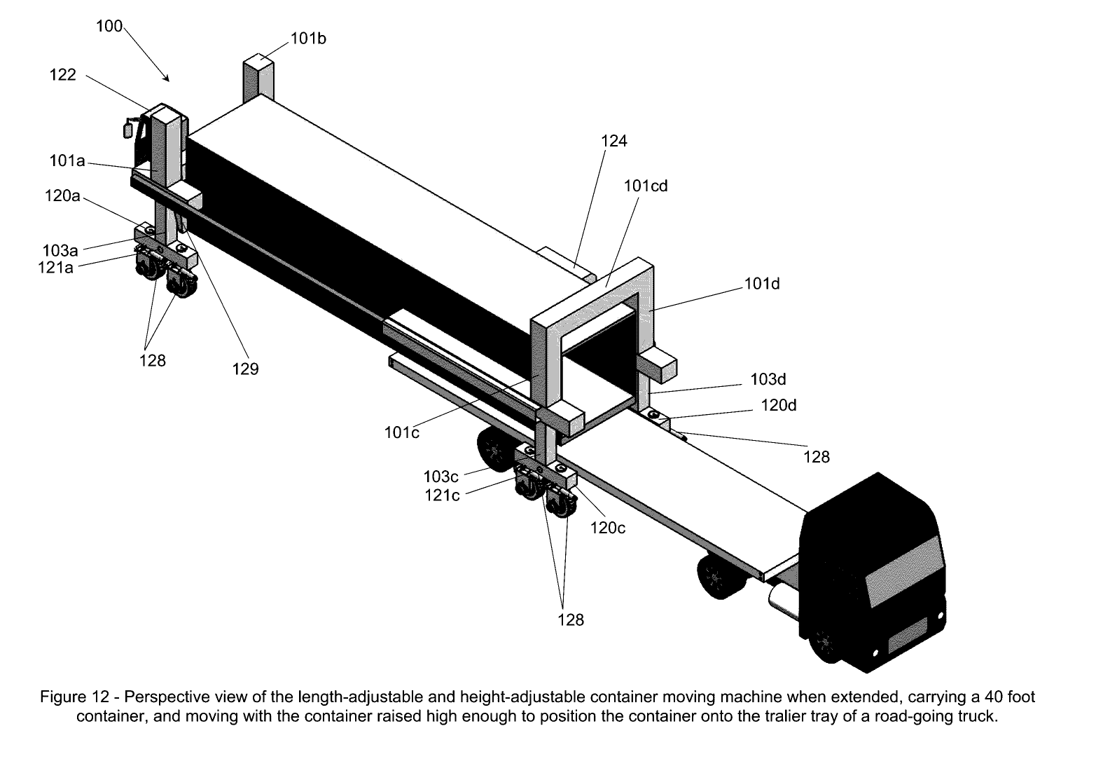

The way in which this two part construction of the legs allows the machine to be height adjustable can be understood by comparing, for example, the Figures which show the machine lowered (see FIG. 8, FIG. 9, FIG. 10, FIG. 11, FIG. 13 and FIG. 14) with the Figures which show the machine raised (see FIG. 6, FIG. 7 and FIG. 12).

As just mentioned, FIG. 6, FIG. 7 and FIG. 12 all show the machine in a raised configuration where the machine's legs are extended. In contrast, FIG. 8 to FIG. 11, FIG. 13 and FIG. 14 all illustrates the machine in a lowered configuration where the legs have been telescopically lowered/retracted such that the overall height of the machine is reduced.

On all four of the machine's legs, the upper sliders 105a-d are mounted so as to be telescopically slidable relative to, and on the outside of, the respective lower pillars 103a-d. Therefore, when the machine's legs 101a-d are telescopically lowered/retracted to convert the machine from the raised configuration (FIG. 6, FIG. 7 and FIG. 12) into the lowered configuration (FIG. 8 to FIG. 11, FIG. 13 and FIG. 14), the upper sliders 105a-d on the respective legs slide telescopically down the outside of the lower main pillars 103a-d. Conversely, when the machine's legs 101a-d are telescopically extended to convert the machine from the lowered configuration into the raised configuration (i.e. in order to raise the machine), the upper sliders 105a-d on the respective legs slide telescopically up relative to the main pillars 103a-d.

The variation in height between the machine's fully lowered and fully raised configurations may well be different in different embodiments, and this may be adjusted or varied to suit the intended application. (For instance, in some applications, it may be necessary to lift shipping containers higher than in other applications, and therefore in those first mentioned applications machines may be configured/made to lift the containers higher than machines configured/made to be used in other applications.) Usually (if not always), when the machine is fully lowered, the machine (or the relevant parts of the machine—see below) will be located close enough to the ground/floor to be able to connect to and lift a shipping container that is initially resting on the ground/floor. However, in terms of the height above the ground/floor to which the machine may be raised, and in particular the height above the ground/floor to which the machine may lift a shipping container, this may vary between embodiments. By way of example (although no limitation whatsoever is to be implied from this), in the embodiments depicted in FIG. 6 to FIG. 14, the machine 100/100′ is operable to lift a shipping container at least high enough to be positioned on the back of a road-going truck, as illustrated in FIG. 12—this will normally be a height above the ground/floor of approximately 1.8 m-2 m. Other embodiments may allow a container to be lifted high enough to be placed on top of another container.

The way in which the upper sliders 105a-d are caused to raise and lower relative to the main pillars 103a-d is actually not critical, and any mechanism or means for achieving this may be used. As an example, in the embodiments shown in FIG. 6 to FIG. 14, a hydraulic lifting/lowering mechanism (not visible) may be housed internally inside the machine's respective legs 101a-d (e.g. a hydraulic ram or the like could be housed inside each of the legs 101 and used to lift and lower the upper slider 105 relative to the main pillar 103). Of course a range of other (hydraulic or non-hydraulic) lifting mechanisms may also be used. In any case, the way in which movement of the upper sliders 105a-d relative to the main pillars 103a-d may be achieved will be understood from the explanations provided above.

The pump(s), etc, required to operate the legs' hydraulic lifting/lowering mechanisms (if these are hydraulic), and indeed other hydraulic systems of the machine, may be housed together with the machine's engine within the machine's engine cover 124. And the hydraulic lifting/lowering mechanisms, as well as the machine's drive and steering controls, and the controls for operating the lengthwise extension/retraction mechanism, etc, may all be controlled using controls located in the driver cabin 122. Thus, the controls for operating the machine 100/100′ are located inside the cabin 122, such that a driver can sit inside the cabin 122 to drive the machine and also to operate the machine's other functions. The driver's cabin 122 in these embodiments is (similar to the embodiment described previously above) mounted on the forward-facing (front) edge of the machine's transverse frame member 160ab. The driver's cabin 122 is therefore (again) located at the front of the machine and faces forward. However, unlike the previous embodiment described with reference to FIG. 2 to FIG. 5 above wherein the engine, etc, was mounted on the front of the machine adjacent the driver's cabin, in the machine 100/100′ depicted in FIG. 6 to FIG. 14 the engine cover 124 is mounted towards the rear of the machine, on the upper side midway along the rear right longitudinal support member 140d.

In any case, still referring to the machine's ability to be height-adjustable, the state of the height extension/retraction of the machine's legs will usually be the same for all of the legs at a given time. In other words, at any given time, the state of extension of one of the legs, and the relative position of its top slider 105 relative to its main pillar 103, will be the same for all of the legs. However, it is also possible that small differences or small progressively controllable variations in the relative positions of the parts of only certain leg(s) (i.e. not all legs at exactly the same height or extension at once) may be used when a container is being lifted, or when the machine is moving carrying the container, for example to slightly tilt or level the container, etc.

It should also be appreciated that the ability of the legs 101a-d to extend and retract in these embodiments is used, not only to adjust the height of the machine (and the height at which the machine carries the shipping container), but this is also the means by which the machine actually raises (i.e. “picks up”) a container off the ground. In other words, when the machine is to pick up a container, the machine must initially be lowered and positioned relative to the container as shown in FIG. 9 and FIG. 13, and the machine's attachment points (container pick up points—discussed below) can attach to the respective bottom corners of the container. Then, once the bottom corners of the container are attached to the machine, the machine's legs can be extended to lift the container off the ground. Sometimes, the machine may lift the container only a small distance off the ground (sufficient for the container to be safely driven/transported without dragging or colliding with the ground). In other circumstances, such as for example where the container is to be placed on a vehicle (as shown in FIG. 12), the machine may need to extend to its fully raised configuration (or close to it) in order to lift the container to a sufficient height to do so.

As mentioned above, the respective legs 101a-101d of the machine are supported above the ground by the wheeled bogies 120a-d. The bogies 120 are, in fact, attached at the base of the respective main pillars 103 in such a way that each bogie 120 can pivot relative to the main pillar 103 to which it is attached. That is, bogie 120a is pivotally attached at the base of upright 101a (to main pillar 103a) by a pivotal connection 121a, bogie 120b is pivotally attached at the base of upright 101b (to main pillar 103b) by a pivotal connection 121b, etc. On each bogie, the location of the pivotal connection, where the bogie is connected to the leg/main pillar, is at the centre of the bogie, equidistant (in the machine's lengthwise direction) between each of the bogie's wheels. The pivotal connection between each bogie and its leg means that the bogies are able to pivot relative to the legs. The bogies can pivot in the plane of their respective legs.

To understand the reason why the bogies are pivotally connected to the legs, imagine that the front wheels (those attached to bogie 120a and 120b) are resting on or moving over level/horizontal ground, however the rear wheels (those attached to bogie 120c and 120d) are resting on or moving over slightly uneven ground which, for example, slopes slightly upwards in the machine's direction of forward movement. In this situation, despite the slightly angled inclination of the ground beneath the rear wheels, nevertheless the wheels attached to bogies 120c and 120d (the machine's rear wheels) can all still remain in contact with the ground, due to the ability of the bogies 120c and 120d to pivot relative to their respective legs, and therefore the machine's rear wheels all continue to help support the weight of the machine.

By way of further explanation, consider another hypothetical example: if bogies 120c and 120d were instead rigidly (non-pivotably) fixed on the ends of their respective legs 101c and 101d (and therefore neither of bogies 120c or 120d could pivot relative to their main pillars 103c and 103d, and if the wheels could not otherwise move vertically relative to the legs), then in this hypothetical situation when the forward wheel of each bogie 120c and 120d reached the sloped section of ground mentioned above, those forward wheels would begin to move up said slope. However, as the forward wheels of bogies 120c and 120d began to move up the slope, this would cause the rearward wheels of bogies 120c and 120d to be un-weighted or it might even lift them into the air (recall that the bogies 120c and 120d cannot pivot in this hypothetical example). This would mean that the entire proportion of the weight borne by legs 101c and 101d would then be transferred to the ground by a single wheel each (the forward wheel of each of bogies 120c and 120d) and therefore this weight would not be shared between the two spaced apart wheels of each bogie 120c and 120d. This could potentially cause or lead to damage to the machine. Thus, the pivotal connection of the bogies to the legs in these embodiments helps to address this problem by allowing weight sharing by both wheels of a given bogie even if said wheels are traveling over uneven ground.

As mentioned above, pump(s) (which may be engine driven or separately powered), and also valves, etc, which operate the machine's hydraulic systems (based on driver controls) may also be located near the engine, nearby or even inside the engine cover 124. Hydraulic lines (not shown) which convey fluid to different parts of the machine may run along the machine's various frame members. For example, there would normally be hydraulic lines extending from the pump (usually near the engine), along the relevant intervening sections of the machine's frame, to the respective hydraulic motors that drive each of the machine's wheels (these hydraulic motors are incorporated in and form part of the respective wheel assemblies 111 but the hydraulic motors themselves are no specifically labelled). Thus, in the depicted embodiment, all of the wheels are “driven” wheels. However, it is possible that in other embodiments, only some wheels (e.g. only the rear wheels, or only the front wheels, etc) of the machine may be driven (e.g. only some of them may have hydraulic motors, or only some of them may be driven in some other way).

In some other embodiments (which differ from the embodiment depicted in FIG. 6 to FIG. 14), only some wheels (e.g. only the front wheels) of the machine may operate to steer the machine. However, in the embodiment actually depicted in FIG. 6 to FIG. 14, all of the machine's wheels can pivot about a vertical axis to contribute to turning/steering the machine when it is in motion. (Or, perhaps more accurately, all of the machine's wheel assemblies 111, or the steering systems associated therewith, can be operated such that their respective wheels can be made to pivot appropriately about a vertical axis to contribute to turning/steering the machine). In any case, the machine in the embodiment depicted in FIG. 6 to FIG. 14 has “8-wheel steering”.

Whilst all of the machine's wheels can potentially pivot/turn at the same time (i.e. all at once) to steer the machine, the amount that each wheel pivots/turns, and the direction in which it pivots/turns, relative to the amount and direction that the others turn, may differ. This is so that the respective wheels each turn in the correct direction and by the correct amount to steer the machine along the desired trajectory. The reason why some or all of the wheels will often turn by a different direction and/or amount compared to others is because the wheels are all located at different positions on the machine, and they must all therefore trace out curved paths of different instantaneous radii as the machine is steered.

In a similar way to the embodiment of the machine depicted in FIG. 2 to FIG. 5 described above, in order to facilitate steering of the machine in FIG. 6 to FIG. 14, powered and controllable steering linkages 128 are provided. The hydraulic cylinders of the respective steering linkages 128 are visible in FIG. 6 to FIG. 14. The respective steering linkages (including the respective hydraulic cylinders thereof) are connected to each of the wheel assemblies 111 and also (in each case) to (or relative to) the respective bogies 120 to which those wheel assemblies 111 are attached. So, for example, on the front left bogie 120a, each of the two steering linkages 128 connect to one of the wheel assemblies 111a and also to (or relative to) the main structure of the bogie 120a, so that each steering linkage 128 can be used to cause its respective wheel assembly 111a to pivot/turn relative to the structure of the bogie 120a. It is exactly the same for all of the other bogies 120 and their respective wheel assemblies. The respective steering linkages (including by operation of the respective hydraulic cylinders) thus control the pivoting of the respective wheel assemblies to ensure that the machine's wheels all turn in the correct direction and by the correct amount when steering the machine. The machine can be steered using controls housed in the driver's cabin 122. In other words, controls in the driver's cabin 122 can be used to operate the steering linkages 128, which in turn pivot (i.e. change the orientation of) the wheels. Naturally, if this is done while the wheels are being driven (by their internal hydraulic motors) to impart motion to the machine, the machine will “corner” (i.e. it will traverse a curved path determined according to the instantaneous orientation of the wheels).

In addition to being height-adjustable, the machine in the embodiment depicted in FIG. 6 to FIG. 14 is also a length-adjustable. In other words, the machine can be extended (lengthened) to increase the spacing between the front legs 101a&b and the rear legs 101c&d, and it can be retracted (shortened) to decrease the spacing between the front legs 101a&b and the rear legs 101c&d. FIG. 6, FIG. 7, FIG. 8, FIG. 9 and FIG. 13 illustrate the machine in an unextended (shortened) configuration, whereas FIG. 10, FIG. 11, FIG. 12 and FIG. 14 illustrate the machine in an extended (lengthened) configuration.

In the specific embodiment depicted in FIG. 6 to FIG. 14, the means by which the machine is length-adjustable (i.e. the structural configuration by which this is made possible) involves structural parts of the machine's frame which can extend, and retract, relative to one another in the machine's longitudinal direction (the longitudinal direction is a direction parallel to the machine's direction of straight-forward movement). The relevant structural parts of the machine's frame include:
short front left and front right longitudinal support members (140a and 140b respectively),
longer rear left and rear right longitudinal support members (140c and 140d respectively),
a left support channel 145c which extends for most of the length along the outside of the longer rear left longitudinal support member 140c,
a right support channel 145d which extends for most of the length along the outside of the longer rear right longitudinal support member 140d,
a long left-hand side extension beam 150ac, and
a long right-hand side extension beam 150bd.

As best illustrated in the Figures which show the machine extended (FIG. 10, FIG. 11, FIG. 12 and FIG. 14), the long extension beam 150ac on the left-hand side is fixedly attached to the front left longitudinal support member 140a. However, the extension beam 150ac is much longer than the front left longitudinal support member 140a, and consequently the extension beam 150ac extends much further in the machine's rearward direction than the front left longitudinal support member 140a. It is the same on the right-hand side of the machine. That is, the long extension beam 150bd on the right-hand side is fixedly attached to the front right longitudinal support member 140b. However, the extension beam 150bd is much longer than the front right longitudinal support member 140b, such that the extension beam 150bd extends much further in the machine's rearward direction than the front right longitudinal support member 140b.

The left and right extension beams 150ac and 150bd do not, however, fixedly attach to the respective left and right rear longitudinal support members 140d or 140d. Instead, the left extension beam 150ac inserts into, and is received in and supported by, the left support channel 145c on the outside of the rear left longitudinal support member 140c. Similarly, the right extension beam 150bd inserts into, and is received in and supported by, the right support channel 145d on the outside of the rear right longitudinal support member 140d. Furthermore, the respective extension beams 150ac and 150bd are slidably received in the respective support channels 145c and 145d. It will therefore be appreciated that, when the machine “extends” in the length-direction, the respective extension beams 150ac and 150bd slide within respective support channels 145c and 145d (the extension beams actually slide in the machine's forward direction relative to the respective support channels) as the spacing between the front of the machine (i.e. the machine's front legs) and the rear of the machine (i.e. the machine's rear legs) increases. Conversely, when the machine “retracts” in the length-direction, the respective extension beams 150ac and 150bd slide within their respective support channels 145c and 145d (in this case the beams actually slide in the machine's rearward direction relative to the respective support channels) as the spacing between the front of the machine and the rear of the machine decreases.

The way in which the spacing between the front of the machine (i.e. the machine's front legs) and the rear of the machine (i.e. the machine's rear legs) is increased, and the creased, is not narrowly critical. In some embodiments, this may be achieved simply by driving only the machine's front wheels forwards while the rear wheels remain stationary, or equally by simply driving the machine's rear wheels rearward while the front wheels remain stationary. However, the extension and retraction of the machine in the length-direction may also be achieved in other ways. For example, a separate hydraulic (or otherwise powered) extension mechanism (not shown) may be provided.

Furthermore, in other embodiments of the invention (not illustrated), the configuration of the machine and its frame, and in particular the way in which the machine is able to be “extended” and “retracted” so as to be length-adjustable may be completely different to what is shown in the embodiment in FIG. 6 to FIG. 14. For example, a “scissor”-like links-extension/retraction mechanism could alternatively be used, and it will be appreciated that this is merely one possible example—numerous other extension/retraction mechanisms are also possible.

It was mentioned while discussing the embodiment in FIG. 2 to FIG. 5 above that transverse member 16ab therein, which extends between the bearers 14ac and 14bd near the front of the machine, therefore connects at right angles to the two side bearers 14ac and 14bd, and it connects the two side bearers 14ac and 14bd together. In the embodiment depicted in FIG. 6 to FIG. 14 it is slightly different. In the embodiment in FIG. 6 to FIG. 14 there is again a transverse frame member 160ab which extends between the two longitudinal sides of the machine's frame, towards the front of the machine. However, in the embodiment in FIG. 6 to FIG. 14, this transverse frame member 160ab actually extends between the forward end of the respective front left and right longitudinal support members 140a and 140b. Also, unlike the embodiment in FIG. 2 to FIG. 5 where the transverse member 16ab is rigidly connected to the respective bearers 14ac and 14bd, in the embodiment in FIG. 6 to FIG. 14, the transverse member 160ab connects on its left-hand side to the left longitudinal support member 140a via a pivotal connection 170a, and likewise on the right-hand side the transverse member 160ab connects to the right longitudinal support member 140b by a pivotal connection 170b. The purpose of these pivotal connections 170a and 170b is to allow the longitudinal structural members of the frame to pivot slightly relative to the transverse member 160ab (and hence the two longitudinal sides of the frame are also able to pivot slightly relative to one another), for example when the machine is moving and travelling over or negotiating uneven ground, etc. This may help to prevent flexure, fatigue, etc, in the machine's frame.

It was mentioned above that the ability of the legs 101a-d to extend and retract is used, not only to adjust the height of the machine (and the height at which the machine carries the shipping container), but this is also the means by which the machine actually raises (i.e. “picks up”) a container off the ground. In the embodiment in FIG. 6 to FIG. 14, the mechanisms used for attaching a container to the machine is similar to that used in the embodiment in FIG. 2 to FIG. 5 described above. That is, twist lock mechanisms are used for this (although, again, other embodiments might use other mechanisms or means for connecting the container to the machine). Again, the twist lock mechanisms themselves are not specifically illustrated in FIG. 6 to FIG. 14. As above, the twist lock mechanisms may be, for example, hydraulically or electrically operated and controllable from within the driver's cabin 122. There is a twist lock mechanism for attaching to each of the four bottom corners of a container, although unlike the machine in the embodiment in FIG. 2 to FIG. 5 which is operable only to lift a 20 foot container, the machine in the embodiment in FIG. 6 to FIG. 14 is (because of its length-adjustability) able to connect to, and lift, a 20 foot container, or a 40 foot container, or potentially a container of a size somewhere in between the two (provided the width, etc, of the container is approximately the same so that the container can fit between, and connect to, the elongate structural portions on either side of the machine).

The twist lock mechanisms are, again, all located on the lower ends of respective downward-hanging structural members 129 (although the twist lock mechanisms could alternatively be located on other low-hanging or on otherwise low or close-to-the-ground portions of the machine). Each twist lock mechanism (again) includes a rotatable lock part which is shaped in such a way that, when attaching a container to the machine, the said lock part of each twist lock mechanism initially inserts through and into one of the ovalized holes 9 in a respective one of the container's lower corners. Once inserted into the hole 9, the lock part of each twist lock mechanism then twists (i.e. each lock part twists when its twist lock mechanism is operated), and because of the shape of the lock part (compared to the ovalized shape of the hole 9), when the lock part twists inside the hole 9, this then prevents the lock part from being withdrawn back out through the hole. More specifically, this twisting causes the lock part (which is then inside the hole 9) to become misaligned with the ovalized hole 9, so that the lock part cannot then be withdrawn from the hole, at least not until the twist lock mechanism is operated again to rotate the lock part back the other way for withdrawal from the hole. Additionally, when one of the lock parts is inserted into one of the holes 9 and twisted, not only does this prevent the lock part from then being withdrawn from the hole, as just described, it also (again due to the shape of the lock part) causes the metal/material of the container around the hole 9 (and hence the container itself as a whole) to be pulled tight and secured firm against the twist lock mechanism. This may again arise due to a camming action by the lock part, for example. Therefore, not only does the turning/twisting of the lock parts in the respective holes 9 secure the lock parts inside the holes, it also pulls the container tight against the respective twist lock mechanisms, thus securing (i.e. holding) the container in position.

The general way in which the twist lock mechanisms operate is described in the previous paragraph. However, it is important (just as it was for the embodiment depicted in FIG. 2 to FIG. 5) to note the locations of the twist lock mechanisms, and hence the locations where the container attaches to the machine 100/100′ in the embodiment in FIG. 6 to FIG. 14. The locations of the twist lock mechanisms, and hence the locations where the container attaches to the machine in this embodiment, are labelled 130.

It is useful to first consider the locations of the attachment points (i.e. the locations of the twist locks where the container attaches to the machine) at the front-end of the machine. Recall that the twist locks are located on the bottom ends of structural members 129. Also, as can be seen in FIG. 10, the structural members 129 at the front end of the machine 100 extend downward directly below the transverse frame member 160ab and below the front longitudinal support members 140a&b. In fact, the location 130 of the two twist lock mechanisms at the very front of the machine, namely the two which allow the two lower holes 9 on the front forward-facing end of a container to connect at the very front end of the machine, are in the same vertical plane and immediately below the rear vertical edge/face of the transverse frame member 160ab, and these two twist lock mechanisms face in the machine's rearward direction. Because the twist lock mechanisms operate to pull the container firmly against themselves when the lock part is inserted into the container holes and twisted, it follows that when a container is attached to the machine 100, and in particular, when the forward end of the container is connected to the two twist lock mechanisms at the very front of the machine and these are operated/twisted, the front end of the container (i.e. the container's forward facing wall) is pulled firmly against not only the twist locks but also against the rear vertical edge/face of the transverse frame member 160ab. Thus, the forward-facing end wall of the container is secured firmly against the two twist locks and also pressed firmly against the back of the transverse frame member 160ab.

Turning now to consider the locations of the attachment points on the sides of the machine, it can be seen from FIG. 8, FIG. 10 and FIG. 11 that the structural members 129 on the sides at the front and rear ends of the machine 100 extend downward from the near the rear of the respective longitudinal support members 140a, 140b, 140c and 140d. All four of these twist lock mechanisms face inwards in the machine's transverse direction, so they connect with the lower holes 9 that are on the outward-facing walls of the container. Because each twist lock mechanism operates to pull the container firmly against itself when the lock part thereof is inserted into the container hole and twisted, it follows that when a container is attached to the machine 100, and in particular, when the sides of the container are connected to the respective inward-pointing twist lock mechanisms on either side of the machine and these are operated/twisted, the two sides of the container are pulled away from each other in opposite directions by the opposing twist locks. The result is that the container becomes rigidly held, in tension, between the twist locks on either side of the machine, and in fact this helps secure/reinforce the machine itself by, for example, helping to prevent outward flexure of the two sides of the machine's frame relative to one another.

Therefore, when a container is secured to the machine 100, regardless of whether it is a 20 foot container or 40 foot container, at the very front the forward-facing end wall of the container is pressed/engaged (and held) firmly against the two very front twist locks and against the back of the transverse frame member 160ab, and on the sides the container is rigidly secured, in tension, between the side twist locks. Hence, the container is securely attached to the machine (so the container can be safely moved if lifted and then driven by the machine), but in addition to this, the container in fact also helps to reinforce (or improve the overall rigidity of) the machine itself, because the container is pulled firmly against (or relative to) the machine in both longitudinal and transverse directions, meaning that the machine is effectively stiffened in both directions by the container. As in the case of the previous embodiment discussed above, one possible consequence of this is that it may be possible for the structure of the machine itself to be made with somewhat less self-reinforcing, and/or from less and/or lighter materials, than might otherwise have been possible were this not the case, and this in turn may help to allow the weight of the machine's structure (and indeed the weight of the machine overall) to be reduced.

At this point it should be noted that alternative embodiments may be provided in which the machine does not have any twist locks or other mechanisms that connect to the forward-facing end wall of the container. For example, there may be embodiments (not illustrated) in which the machine is almost the same as in FIG. 6 to FIG. 14, but where the machine only has structural members 129 depending down from the side longitudinal support members 140a, 140b, 140c and 140d and hence only has inwardly (transversely) facing twist locks that connect to the bottom corners of the long sides of the container (i.e. such that the machine only connects to the long sides of the container). In such embodiments, the container consequently may not be pressed/engaged (and held) firmly against the back of the transverse frame member 160ab, for example, or at least not by the operation of the twist locks. Nevertheless, in such embodiments, the container may still be held firmly by the said (all inward/transversely facing) twist locks, including being held firmly in the container/machine's lengthwise direction. In other words, this possible alternative arrangement may still operate (or be capable of operating) to secure the short side of the container (and indeed the container as a whole as a result) and hold it in position relative to the machine's short-side structural member 160ab (and thus relative to the machine is a whole). Hence, this alternative configuration may also allow the inherent structural rigidity and stiffness of the container to be used to enhance the rigidity and stiffness of the machine. And so, again, it may be possible for the structure of the machine itself to be made with less self-reinforcing, and/or from less and/or lighter materials, than might otherwise have been possible had this not been the case, and this in turn may help to allow the weight of the machine's structure (and indeed the weight of the machine overall) to be significantly reduced.

In the present specification and claims (if any), the word ‘comprising’ and its derivatives including ‘comprises’ and ‘comprise’ include each of the stated integers but does not exclude the inclusion of one or more further integers.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A controllably movable machine for moving a shipping container, wherein a shipping container can be connected to the machine such that, when the container is connected to the machine and the machine moves, the container moves with the machine, the machine having
long-side structural members that extend generally along or adjacent the long sides of the container when the container is connected to the machine, and
at least one short-side structural member that extends between the long-side structural members,
wherein, when the container is connected to the machine, one of the short sides of the container is secured against or relative to the short-side structural member, and the container is secured between the long-side structural members, in such a way that the container contributes to or supports the structure of the machine.

2. The machine as claimed in claim 1, wherein there are two long-side structural members, one extending along or adjacent to each of the respective long sides of the container when the container is connected to the machine.

3. The machine as claimed in claim 2, wherein there is a single short-side structural member, and the short-side structural member extends between the two long-side structural members near one end of the respective long-side structural members.

4. The machine as claimed in claim 3, wherein the length of the short-side structural member is slightly larger than the width of the container.

5. The machine as claimed in claim 3 wherein, in use, when the machine is viewed from above, the plan-form shape formed by the two long-side structural members and the short-side structural member is a general “U”-shape into which the shipping container can be inserted lengthwise to be connected to the machine.

6. The machine as claimed in claim 5 wherein, in use the two long-side structural members and the short-side structural member all reside in a plane substantially parallel to the ground and together form a flat, horizontally extending “U”-shape into which the shipping container can be inserted lengthwise to be connected to the machine.

7. The machine as claimed in claim 1 further comprising a plurality of wheel assemblies, wherein wheels of the wheel assemblies contact the ground and the wheel assemblies support the long-side structural members and the short-side structural member(s) above the ground.

8. The machine as claimed in claim 7, wherein there is a single short-side structural member, and the short-side structural member extends between the two long-side structural members near one end of the respective long-side structural members and wherein there is at least one wheel assembly at or near the end of the machine where the short-side structural member extends between the two long-side structural members, and at least one wheel assembly supporting each respective long-side structural member near the opposite end thereof from the end connected to the short-side structural member.

9. The machine as claimed in claim 8, wherein the machine has a total of eight wheel assemblies, four attached directly or indirectly to each long-side structural member, and of four the wheel assemblies attached to each long-side structural member two are located towards the end of said long-side structural member that is connected to the short-side structural member and two are located toward the opposite end.

10. The machine as claimed in claim 7, wherein all of the machine's wheel assemblies, or steering mechanism(s) associated therewith, can be operated such that their respective wheels pivot about a vertical axis to contribute to turning/steering the machine.

11. The machine as claimed in claim 7 wherein all of the machine's wheels are “driven”.

12. The machine as claimed in claim 1 wherein the machine is operable, once a container that is resting on the ground is connected to the machine, to lift the container off the ground to a sufficient height for the container to be subsequently moved without dragging along the ground or without striking the ground as it is moved over uneven sections of ground, and the machine is also operable to lower the container back down onto the ground.

13. The machine as claimed in claim 12 wherein, when the container is connected to the machine, the container is fixed in position relative to the long-side and short-side structural members, and the machine operates to lift, and lower, the container by respectively raising, and lowering, the long-side and short-side structural members relative to the ground.

14. The machine as claimed in claim 13, including a plurality of wheel assemblies, wherein wheels of the wheel assemblies contact the ground and the wheel assemblies support the long-side structural members and the short-side structural member(s) above the ground and wherein the wheel assemblies (or some of them) incorporate mechanisms operable to raise, and lower, the long-side and short-side structural members relative to the ground.

15. The machine as claimed in claim 12, wherein the machine has attachment points where the machine connects to the container in order that, when the container is connected to the machine, the container is fixed in position relative to the long-side and short-side structural members.

16. The machine as claimed in claim 15 wherein there are at least four attachment points where the machine connects to the container near the lower corners of the container.

17. The machine as claimed in claim 15 wherein the attachment points are located on structural parts of the machine that hang or otherwise reside below the short-side and long-side structural members.

18. The machine as claimed in claim 15, wherein a mechanism is provided at some or all of the attachment points that both connects the attachment point to a point on the container and also secures the said point on the container against (or otherwise relative to) the attachment point.

19. The machine as claimed in claim 18 wherein the mechanism provided at some or all of the attachment points, is a twist lock mechanism.

20. The machine as claimed in claim 1 wherein the machine is extendable to accommodate containers of differing long-side dimensions.

21. The machine as claimed in claim 2, wherein the two long-side structural members are each made up of multiple parts, and in each case one or more of the parts are movable relative to one or more other parts such that the machine is extendable to accommodate containers of differing long-side dimensions.

22. The machine as claimed in claim 1 wherein the machine is operable to lift a container to a height sufficient to place the container on top of another container or onto a road-going or rail vehicle.

23. The machine as claimed claim 22 wherein when the container is connected to the machine, the container is fixed in position relative to the long-side and short-side structural members, and the machine operates to lift, and lower, the container by respectively raising, and lowering, the long-side and short-side structural members relative to the ground, and the machine incorporates a plurality of height-adjustable frame members which are operable to raise, and lower, the long-side and short-side structural members.

24. The machine as claimed in claim 23 wherein the plurality of height-adjustable frame members includes a plurality of telescopically height-adjustable uprights.

25. The machine as claimed in claim 24 wherein the machine's wheel assemblies are connected directly to wheel assembly support members, the height-adjustable uprights connect the wheel assembly support members to the long-side and short-side structural members, and increasing or decreasing the height of the uprights causes the vertical distance between the wheel assembly support members and the long-side and short-side structural members to increase or decrease.

26. A controllably movable machine for moving a shipping container, wherein a shipping container can be connected to the machine such that, when the container is connected to the machine and the machine moves, the container moves with the machine, the machine having
short-side structural members that extend generally along or adjacent the short sides of the container when the container is connected to the machine, and
at least one long-side structural member that extends between the short-side structural members,
wherein, when the container is connected to the machine, one of the long sides of the container is secured against or relative to the long-side structural member, and the container is secured between the short-side structural members, in such a way that the container contributes to or supports the structure and/or rigidity of the machine.
